(19) United States
(12) Patent Application Publication
(10) Pub. No.: US 2026/0289071 A1
(43) Pub. Date: Sep. 24, 2026

(54) SYSTEM

(71) Applicant: SoftBank Group Corp., Tokyo (JP)

(72) Inventor: Junki MORITA, Tokyo (JP)

(73) Assignee: SoftBank Group Corp., Tokyo (JP)

(21) Appl. No.: 19/566,996

(22) Filed: Mar. 14, 2026

(30) Foreign Application Priority Data
Mar. 19, 2025 (JP) 2025-045101

(51) Int. Cl. G06F 40/157; G06F 40/205; G06F 40/284; G06N 3/0475

(52) U.S. Cl. CPC G06F 40/157; G06F 40/205; G06F 40/284; G06N 3/0475

(57) ABSTRACT

A system includes a processor that is configured to receive, as an input, a daily schedule of a user, transmit schedule data input via an interface to an information processing device, and generate a prompt for instructing a generative AI model to generate proposals for efficient task management based on stored data, and transmit the prompt to the generative AI model.

### CROSS-REFERENCE TO RELATED APPLICATION

This application is based on and claims priority under 35 USC 119 from Japanese Patent Application No. 2025-045101 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional schedule management systems primarily function as passive tools that allow a user to input events and display them in a calendar format. Such systems do not actively analyze a user's daily schedule or stored data to generate proposals for efficient task management tailored to the user's actual working patterns. As a result, the user must manually consider how to prioritize tasks, when to perform certain activities, and how to arrange the schedule for improved productivity. This imposes a cognitive burden on the user and often leads to suboptimal time allocation, missed opportunities for efficiency, and difficulty in adapting the schedule as circumstances change. Moreover, even when generative AI models are available, there is no integrated mechanism for generating appropriate prompts based on the user's stored schedule data, obtaining AI-generated proposals, and embedding such proposals into the schedule in a way that is easy for the user to understand and act upon. Accordingly, there is a need for a system that can automatically receive a user's daily schedule, cooperate with an external information processing device and a generative AI model, and provide the user with visual and timely proposals for efficient task management without requiring complex manual operations.

### SUMMARY

In order to solve the above-described problems, a system is provided comprising a processor, wherein the processor is configured to receive, as an input, a daily schedule of a user; transmit schedule data input via an interface to an information processing device; and generate a prompt for instructing a generative AI model to generate proposals for efficient task management based on stored data, and transmit the prompt to the generative AI model. The processor is further configured to receive a response from the generative AI model and visually present the response to the user, for example by displaying, on a terminal device, proposals indicating recommended task ordering, time allocation, or insertion of additional activities. In addition, the processor is configured to incorporate proposals from the generative AI model into the schedule in accordance with the user's schedule and notify the user of the updated schedule or newly added items. By automatically generating prompts, obtaining AI-generated proposals, integrating the proposals into the user's schedule, and providing visual notifications to the user, the system reduces the cognitive burden on the user and enables more efficient task management that dynamically reflects the user's actual daily schedule.

The term “system” refers to an arrangement including at least one hardware device and a processor, and optionally one or more terminal devices and network resources, that cooperatively execute the functions described in the claims.

The term “processor” refers to one or more hardware processing units, such as a central processing unit (CPU), microprocessor, digital signal processor (DSP), or other processing circuitry, configured by software or firmware to execute programmed instructions that realize the claimed functions.

The term “daily schedule of a user” refers to information representing planned activities, events, or time slots for a user within a predetermined period of approximately one day, including at least start times and end times and optionally event titles, categories, or priorities.

The term “interface” refers to a hardware and/or software component through which the user or a terminal device inputs schedule data to the system, including, for example, a graphical user interface, an application programming interface (API), or an input screen on a terminal device.

The term “schedule data” refers to structured data representing one or more schedule items in the user's daily schedule, including at least time information and optionally associated metadata such as event names, types, or descriptions.

The term “information processing device” refers to a device, which may be local or remote with respect to the processor, that is capable of receiving the schedule data and executing information processing operations such as data storage, retrieval, analysis, or cooperation with a generative AI model.

The term “stored data” refers to data retained in a storage device accessible to the system, including at least the schedule data and optionally historical usage records, user preference information, task metadata, or other information used as a basis for generating proposals for efficient task management.

The term “generative AI model” refers to a machine learning model, such as a large language model or other generative model, that is capable of generating text or other content, including proposals for efficient task management, in response to a prompt.

The term “prompt” refers to data, typically including text, parameters, or structured information, that is generated by the processor and transmitted to the generative AI model to instruct the generative AI model to output proposals for efficient task management based on stored data.

The term “proposals for efficient task management” refers to suggestions generated by the generative AI model, including but not limited to recommendations on task ordering, scheduling, grouping, splitting, postponing, or inserting tasks, with the aim of improving the user's productivity, time utilization, or workload balance.

The term “response from the generative AI model” refers to output data produced by the generative AI model in reply to a transmitted prompt, the output data including at least the proposals for efficient task management.

The term “visually present” refers to causing information to be displayed in a human-readable form on a display device, such as a screen of a terminal, including text, icons, charts, or other graphical elements representing the response from the generative AI model.

The term “terminal device” refers to an electronic device operated by the user, such as a smartphone, tablet, personal computer, or wearable device, that is capable of displaying information and accepting user input and communicating with the system.

The term “incorporate proposals into the schedule” refers to processing in which the processor modifies, augments, or reorganizes the user's schedule based on the proposals for efficient task management, including adding new schedule items, changing times of existing items, or annotating items with recommended actions.

The term “notify the user” refers to providing information to the user through a notification mechanism, such as push notifications, alerts, pop-up messages, or other display outputs or signals on the terminal device, indicating at least that the schedule has been updated or that specific proposals are available.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

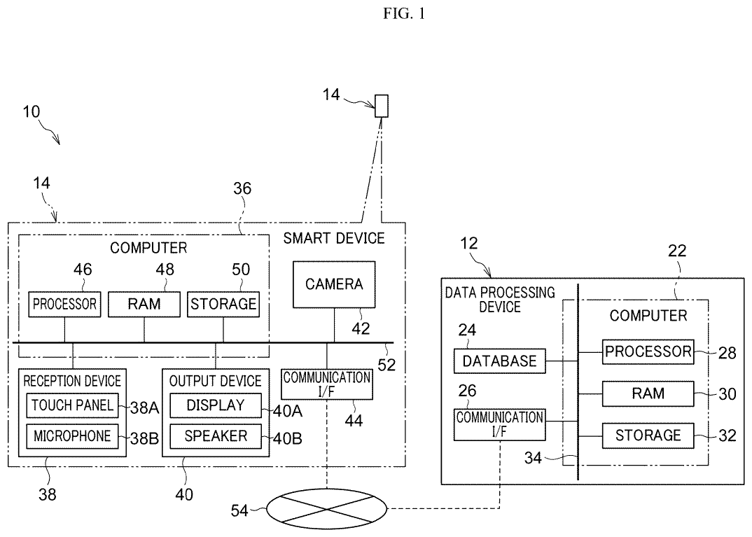

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

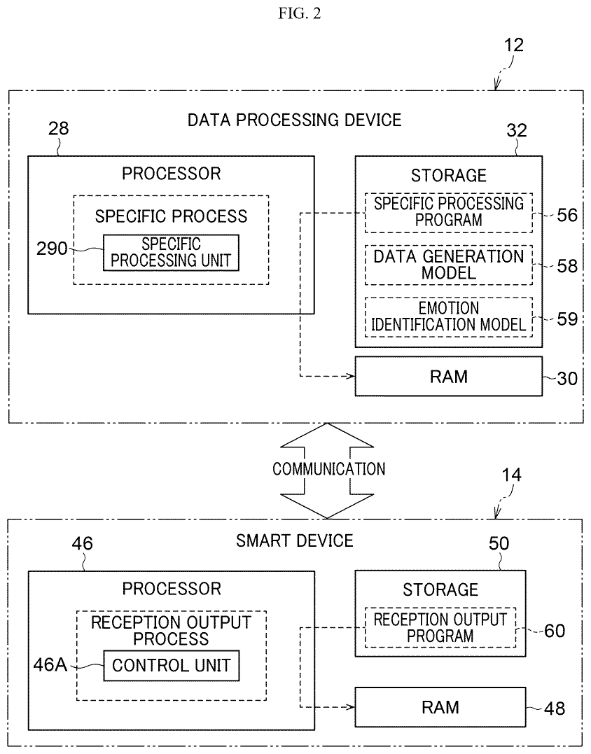

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional schedule management systems typically rely on static rule engines or manually configured templates to generate work plans. These systems generally treat schedule data as simple calendar entries and are not architected to exploit advanced natural language generation capabilities. As a result, such systems are limited in their ability to dynamically synthesize personalized, context-aware work management proposals from heterogeneous schedule data in a reliable, repeatable, and machine-verifiable manner.

In particular, existing systems often lack a well-defined computational pipeline that: (i) validates and normalizes raw schedule data received from user terminals, (ii) transforms such data into structured representations suitable for both storage and downstream machine processing, (iii) constructs prompt sentences that precisely encode schedule context and instructions for a generative AI model, (iv) interfaces with an external or internal generative AI inference apparatus in a robust and protocol-compliant way, and (v) post-processes the generated natural-language proposals into structured information aligned with the original schedule time segments. Because these stages are not tightly integrated at the system and data-flow level, prior approaches may produce inconsistent results, require substantial manual intervention, or fail to scale across diverse user environments and devices.

Furthermore, conventional architectures do not adequately address how to systematically map generated natural-language proposals back onto machine-tractable schedule structures that can be stored, updated, and re-used in subsequent computations. In many cases, generated suggestions are displayed as free text without being incorporated into the underlying schedule model, which prevents automated updating of schedule data, automated notification generation, or iterative refinement of the schedule based on newly generated proposals. This disconnect between generative AI output and schedule data structures reduces the technical efficacy and reusability of the system.

Accordingly, there is a need for an improved computer-implemented system that provides a concrete, technical mechanism for: (a) receiving and validating schedule data from user terminals, (b) converting validated data into structured representations stored in a storage device, (c) generating prompt sentences that integrate such structured schedule representations with explicit instruction information, (d) interoperating in a standardized manner with a generative AI model executing natural language processing, and (e) transforming the resulting proposals into both display-ready information and updated schedule data. Such a system should enhance the overall reliability, consistency, and efficiency of schedule-based work management by improving how computing resources process, integrate, and reuse schedule data and generative AI output.

The specific processing by the specific processing unit 290 of the data processing device 12 in Example 1 is realized by the following means.

The present invention provides a server comprising a processor and a storage device, the processor being configured to receive, via a communication network, schedule data transmitted from a user terminal, the schedule data including time information and content information relating to daily activities of a user; execute data validation processing on the received schedule data by verifying consistency including a time format and presence of required items, and store validated schedule data as structured information in the storage device in association with identification information; generate description information representing activity time periods and activity types of the user based on the stored schedule data, and generate a prompt by creating a prompt sentence including the description information and instruction information requesting proposals for efficient work management based on the user schedule; transmit the generated prompt, in accordance with a communication protocol, to a generative artificial intelligence model implemented by an external inference apparatus or an internal inference apparatus, and request a proposal generation process based on natural language processing by the generative artificial intelligence model; receive, from the generative artificial intelligence model, response data including work management proposals generated in response to the prompt and associated with the schedule data of the user, and convert the response data into display information suitable for presentation by a user interface; reconstruct the work management proposals as time-period-specific proposal information by associating the work management proposals with respective time segments of the schedule data of the user, and generate display control information that uses the time-period-specific proposal information to superimpose proposal content on a time-axis display or list display representing the schedule data of the user; and generate updated schedule data by adding new activity information or activity-segment information to the stored schedule data, or by modifying time periods or content of existing activity information, based on the work management proposals, re-store the updated schedule data in the storage device in association with identification information of the user, and generate notification information based on the updated schedule data and transmit the notification information to the user terminal. This enables an integrated, computer-implemented pipeline in which schedule data are validated, structured, and stored, prompt sentences are automatically constructed and supplied to a generative AI model, and AI-generated proposals are programmatically mapped back to schedule structures, thereby improving the reliability, scalability, and technical efficiency of schedule-based work management performed by the server.

The term “system” refers to an arrangement of one or more computing devices, including at least a processor and a storage device, configured to execute the processing operations described in the claims.

The term “processor” refers to one or more hardware processing units, such as a central processing unit or a graphics processing unit, and equivalents thereof, capable of executing instructions to perform arithmetic, logical, control, and input/output operations.

The term “storage device” refers to one or more physical data storage components, such as a semiconductor memory, magnetic storage, or optical storage, configured to store program code, schedule data, prompts, response data, and other information in a machine-readable form.

The term “communication network” refers to any wired or wireless communication infrastructure, including local networks and wide-area networks, that enables data transmission between a user terminal, the system, and a generative artificial intelligence model.

The term “user terminal” refers to an electronic device operated by a user, such as a computing device with a user interface and communication capability, configured to transmit schedule data to the system and receive display information or notification information from the system.

The term “schedule data” refers to information that describes temporal aspects and content aspects of daily activities of a user, including at least time information and content information associated with the activities.

The term “time information” refers to data elements indicating temporal parameters of activities, such as start times, end times, durations, and time ranges, expressed in a predefined format.

The term “content information” refers to data elements that describe the type, category, or description of activities corresponding to the time information, such as work tasks, meetings, and breaks.

The term “data validation processing” refers to a series of operations executed by the processor to check whether received schedule data satisfy predetermined consistency conditions, including format constraints and presence of required items.

The term “consistency” refers to conformity of the schedule data to predefined rules, such as correct time formats, required fields being present, and logical relationships among time segments being preserved.

The term “required items” refers to data elements that must be present in the schedule data for the data to be considered valid, such as basic activity times, identification information, or minimum activity descriptors.

The term “structured information” refers to schedule data represented in a predefined data schema or format, such as records, tables, or objects, that allow systematic storage, retrieval, and processing by the system.

The term “identification information” refers to information that uniquely or distinctively associates schedule data or updated schedule data with a particular user or account, such as a user identifier, device identifier, or session identifier.

The term “description information” refers to data generated by the processor that expresses, in a machine-processable or human-readable form, the activity time periods and activity types of the user derived from the stored schedule data.

The term “activity time periods” refers to time ranges or intervals associated with specific activities in the schedule, including at least start times and end times.

The term “activity types” refers to classifications or categories of activities performed by the user, such as focused work, administrative work, meetings, or breaks.

The term “prompt” refers to a machine-readable request supplied to a generative artificial intelligence model, including at least a prompt sentence and optionally additional parameters, instructing the model to generate work management proposals.

The term “prompt sentence” refers to a natural-language expression constructed by the processor that combines description information and instruction information to request a particular type of output from a generative artificial intelligence model.

The term “instruction information” refers to data included in the prompt that specifies a task or constraint for the generative artificial intelligence model, such as requesting proposals for efficient work management based on the user schedule.

The term “generative artificial intelligence model” refers to a trained machine learning model configured to generate natural-language output or other structured content in response to a prompt, using probabilistic or neural network-based processing.

The term “external inference apparatus” refers to a computing environment located outside the system, such as a remote server or cloud-based service, that executes inference operations of the generative artificial intelligence model.

The term “internal inference apparatus” refers to a computing environment implemented within the system, such as a local server or on-device runtime, that executes inference operations of the generative artificial intelligence model.

The term “communication protocol” refers to a set of rules and formats, such as network-layer and application-layer protocols, that govern how the processor transmits prompts and receives responses from the generative artificial intelligence model.

The term “proposal generation process” refers to the inference operation executed by the generative artificial intelligence model in response to a prompt, resulting in the creation of work management proposals.

The term “natural language processing” refers to computational processing by which the generative artificial intelligence model interprets and generates text data in human languages based on numerical representations.

The term “response data” refers to data returned from the generative artificial intelligence model to the processor, including at least natural-language text representing work management proposals associated with the schedule data.

The term “work management proposals” refers to recommendations or plans generated by the generative artificial intelligence model that specify how the user should allocate or manage tasks and activities over the schedule.

The term “display information” refers to data derived from response data and structured so that a user interface can present the work management proposals in a visually perceptible manner.

The term “user interface” refers to software and hardware components of the user terminal or system that visually present information to the user and optionally accept input from the user.

The term “time-period-specific proposal information” refers to proposal data that are organized and associated with respective time segments of the user's schedule, thereby aligning generated suggestions with particular activity time periods.

The term “display control information” refers to data used by a rendering process to determine how to visually present schedule data and time-period-specific proposal information on a time-axis display or list display.

The term “time-axis display” refers to a graphical representation of schedule data along a temporal axis, in which activities and associated proposals are arranged by time order.

The term “list display” refers to a representation of schedule data and associated proposals in a list format, in which time segments and activities are displayed as list items.

The term “updated schedule data” refers to schedule data that have been programmatically modified by the processor, based on work management proposals, by adding, removing, or changing activity information or time periods.

The term “activity information” refers to data elements in the schedule that specify the content, label, or category of an activity and its associated temporal context.

The term “activity-segment information” refers to finer-grained temporal divisions or sub-intervals of activities, each associated with particular tasks or classifications.

The term “notification information” refers to data generated by the processor to inform the user about updated schedule data, upcoming activities, or revised work management proposals, and transmitted to the user terminal for presentation.

In one embodiment, a server cooperates with a terminal operated by a user to implement the claimed system. The server includes at least one hardware processor, a main memory, a nonvolatile storage device, and a network interface. The terminal includes a display, an input device, a network interface, and a local processor that executes a web browser or a dedicated application.

The server executes a program implemented on a general-purpose operating system running on the hardware processor. The server uses a web server module to expose an application endpoint accessible from the terminal. In one example, the server uses a hypertext transfer protocol server and an application framework that supports structured request handling and response generation. The server stores schedule data and updated schedule data in a relational database management system executing on the storage device. In one example, the server uses a relational database engine that stores records in tables with indexed fields. The server communicates with a generative AI model using a secure network connection and an application programming interface.

The terminal executes a web browser or native application to present an input interface and an output interface to the user. The user uses the terminal to input schedule data including activity start times, end times, and descriptive labels such as “project work,” “meeting,” or “break.” The terminal converts the user input into structured request data and transmits the request data to the server via the communication network. The terminal receives response data and notification information from the server, and the terminal renders visual elements such as time-axis displays and lists on the display device based on the received data.

The server receives schedule data from the terminal using the network interface and passes the data to the application program executing on the processor. The server represents the schedule data as an internal data structure, for example, an object structure containing fields for user identification, activity identifiers, start times, end times, and content descriptions. The server executes data validation logic that verifies conformity of time strings to a predefined format, verifies that required fields such as user identification and activity intervals are present, and verifies that time intervals do not overlap in a logically inconsistent manner. The server uses algorithmic checks implemented as arithmetic and logical operations on time values converted to numeric representations. The server rejects malformed schedule data and returns descriptive error information to the terminal, thereby preventing storage of corrupted records.

The server stores validated schedule data in the relational database engine as rows in a schedule table. The server associates each row with identification information of the user and with a logical schedule identifier. The server uses indexed columns for user identification and time intervals. The server uses such indexing to accelerate retrieval of schedules when constructing prompts and when reconstructing time-period-specific proposal information. This structured storage and indexing improve the speed and scalability of schedule retrieval operations, particularly when the server manages schedules for a large number of users.

The server generates description information by transforming structured schedule records into a normalized intermediate representation. The server converts each activity record into a representation containing a time interval, an activity type classification, and a priority or importance value if available. The server maps raw content descriptions to controlled activity types such as “deep work,” “administrative work,” “meeting,” or “break” using a classification table. This mapping enables the server to present schedule context to the generative AI model in a compact and standardized form.

The server generates a prompt sentence that includes the description information and explicit instruction information. In one example, the server generates a prompt sentence such as: “Based on the following schedule, please provide efficient task management suggestions. The user works from 09:00 to 18:00, has a lunch break from 12:00 to 13:00, and has a project meeting from 15:00 to 16:00.”

In another example, the server generates a prompt sentence such as: “You are a productivity consultant. Using the user's schedule described below, create a detailed time-blocking plan with recommended task types for each block. Schedule: work from 08:30 to 17:30, lunch break from 12:00 to 13:00, team meeting from 16:00 to 17:00.”

In still another example, the server generates a prompt sentence such as: “Given this one-day schedule, please provide three alternative task management strategies that the user can choose from, focusing respectively on speed, quality, and balance. Schedule: work from 09:00 to 18:00, lunch from 12:00 to 13:00, and two meetings from 14:00 to 15:00 and from 16:00 to 17:00.”

The server incorporates not only raw times but also normalized activity types and optional constraints such as maximum consecutive deep-work duration or minimum break intervals. The server thus creates a prompt that encodes both structural schedule constraints and high-level instructions. This structured prompt generation improves the relevance and consistency of responses compared with unstructured natural-language input.

The server transmits the generated prompt to a generative AI model running on an external inference apparatus or on an internal inference apparatus. The server uses an application protocol such as a request-response protocol over a secure transport. The server includes model parameters such as maximum token length, temperature, and top-k or top-p sampling settings in the request. The server selects such parameters based on device capabilities and latency constraints. For example, the server may reduce maximum token length and temperature when a low-latency response is required, thereby reducing network traffic and inference time.

In one embodiment, the generative AI model is implemented as a transformer-based neural network comprising an input embedding layer, multiple self-attention layers, feed-forward layers, and an output layer. The model parameters include weight matrices for token embeddings, attention projections, and feed-forward transformations. The model receives tokenized prompt sentences, converts tokens into embedding vectors, and processes the vectors through multiple attention heads and layers. The model computes attention scores as dot products of query and key vectors, normalized by a scaling factor, and applies softmax functions to derive attention weights. The model uses such attention weights to aggregate value vectors and propagate contextual information across time positions in the sequence. The model uses non-linear activation functions, such as rectified linear units or Gaussian error linear units, in the feed-forward layers to introduce non-linearity.

The generative AI model is trained prior to deployment by minimizing a loss function such as cross-entropy between predicted tokens and reference tokens over a large corpus of schedule-related and task-management-related text. During training, the model updates weight parameters using gradient-based optimization such as stochastic gradient descent or an adaptive method. The training process uses backpropagation to propagate error gradients through the network layers. The training phase may include fine-tuning with domain-specific data sets that describe work schedules and productivity advice. The training process may apply data augmentation techniques to vary phrasing and time patterns in schedule descriptions, thereby improving generalization to diverse user inputs.

The server does not rely on simple template substitution or rule-based text generation. Instead, the server cooperates with the trained neural network to leverage learned statistical relationships between schedule patterns and suitable task allocations. The server thereby obtains proposals that adapt to irregular schedules, overlapping tasks, and variable constraints that would be difficult to encode using static rules. The use of a generative AI model in this structured manner improves the technical behavior of the system by reducing the need for hand-crafted rules and by providing more accurate and context-aware allocations with lower maintenance costs.

The server receives response data from the generative AI model as a sequence of tokens representing a natural-language proposal. The server decodes the tokens into text and parses the text using pattern matching and structured parsing methods. The server uses predetermined markers, phrases, and formatting conventions to segment the text into time-period-specific proposals. For example, the server identifies expressions such as “from 09:00 to 11:00,” “between 13:00 and 15:00,” or “in the afternoon” and aligns these expressions with the existing schedule intervals. The server constructs a time-period-specific proposal structure that associates each schedule interval with one or more recommended task types, priorities, or preparation steps.

The server converts the parsed proposals into display information and display control information. The server generates view models for a time-axis display, including coordinates for activity blocks and overlay positions for proposal text. The server also generates models for a list display, where each list item corresponds to a schedule interval and contains both original content information and proposed modifications. The server transmits such display information to the terminal as structured response data. The terminal uses local rendering logic to draw graphical elements on the display, such as colored bars representing activity types and overlay labels representing proposals.

The server also generates updated schedule data by programmatically integrating selected proposals into the schedule structure. The server may, for example, split a long work interval into multiple sub-intervals as suggested by the generative AI model, such as “09:00-10:30 deep work” and “10:30-11:00 email review.” The server modifies the schedule table to add new records representing sub-intervals and to adjust start and end times of existing records.

The server preserves the original schedule as a versioned entry and creates a new version storing the updated structure. This versioning mechanism improves reliability by enabling rollback and by providing a history of modifications.

The server computes notification information based on updated schedule data and device context of the user. The server may, for instance, generate reminders for new deep-work intervals or preparation periods before meetings. The server schedules notification times so that network transmissions and processing peaks are balanced, thereby reducing communication load. The server uses batched transmissions to send multiple notifications at once when possible, reducing protocol overhead and conserving bandwidth.

The server improves technical performance in several ways. First, the server reduces response latency by validating and normalizing schedule data before constructing prompts, thereby preventing unnecessary AI calls due to invalid input. Second, the server reduces communication overhead by encoding structured schedule context compactly and by tuning prompt length and model parameters for each use case. Third, the server improves computational efficiency by using indexed relational storage and pre-computed descriptions, thereby reducing the amount of processing required for each new prompt. Fourth, the server improves accuracy and consistency of schedule updates by converting free-text proposals into structured, time-aligned records through parsing and alignment algorithms, rather than leaving proposals as unstructured text.

The server implements specific, non-conventional rules and procedures for integrating the generative AI model into the schedule management pipeline. The server uses a non-trivial mapping from schedule records to prompt sentences and a corresponding inverse mapping from proposal text to updated schedule records. The server does not simply automate human reading and writing; instead, the server defines input constraints, data schemas, indexing strategies, parsing rules, and model parameter settings that optimize the behavior of the combined system. These components cooperate to provide improvements in data management, processing speed, and error reduction that would not be obtained by manual schedule planning or by naïve use of a generative AI model.

The user interacts with the system through the terminal but does not need to understand the internal data structures or AI algorithms. The user supplies simple schedule information, such as “work from 09:00 to 18:00, lunch from 12:00 to 13:00, meeting from 15:00 to 16:00,” and the server automatically converts this information into validated records, structured prompts, AI inferences, and updated schedules. The user can review and accept or adjust the proposals shown on the terminal display. The user thus benefits from a technically enhanced scheduling process where underlying computer components perform optimized data processing, storage management, and neural network inference.

In alternative embodiments, the server can employ different database engines, different application frameworks, and different generative AI architectures. The server can use a recurrent neural network, a convolutional neural network, or a hybrid model instead of a transformer-based model, provided that the model is trained to generate natural-language proposals from schedule-like input. The server can store schedule data in non-relational databases using key-value or document-oriented formats, while still maintaining structured fields for user identification, time intervals, and activity types. The server can run the generative AI model internally on a specialized accelerator for inference, such as a tensor processing device, to further reduce latency and dependency on external services.

In all such embodiments, the server maintains the core technical features of validating schedule data, structuring the data in a machine-optimized schema, constructing prompt sentences that encode schedule context and instructions, invoking a trained generative AI model using standardized protocols and parameters, parsing and aligning resulting natural-language proposals back to schedule structures, and updating stored schedules and notifications based on those proposals. By tightly integrating these features, the system produces technical effects including faster processing, more accurate alignment between free-text proposals and structured schedules, improved data consistency across versions, and reduced communication and computation overhead, thereby constituting an improvement in computer-based schedule management technology.

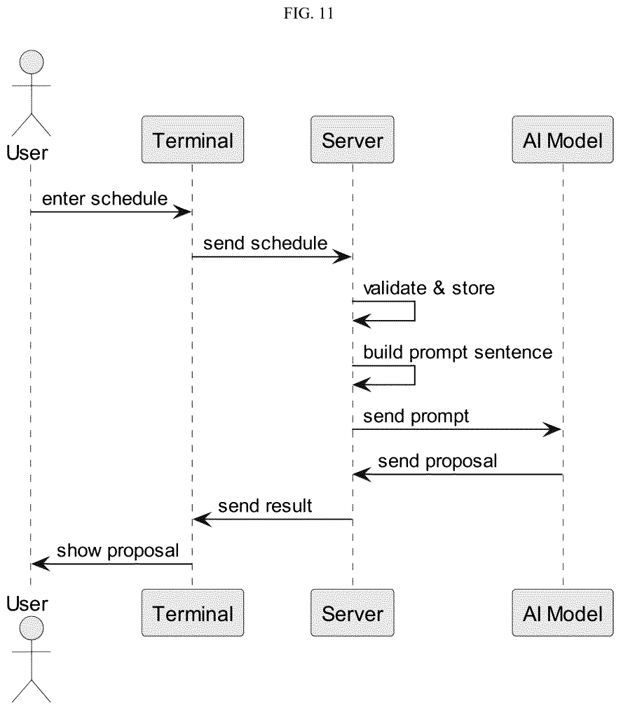

The following describes the processing flow using FIG. 11.

### Step 1

The user operates the terminal to open an application screen for schedule input.

The terminal receives user input such as work start time, work end time, break times, and meeting times.

The terminal converts this input into an internal data structure, for example a set of fields containing user identification, activity labels, and time strings.

The terminal outputs the structured schedule input data as the result of this step.

### Step 2

The terminal receives the structured schedule input data from the user interaction layer.

The terminal encodes the schedule input data into a request payload, for example by converting field values into a format suitable for transmission to the server.

The terminal generates an HTTP request that includes the encoded schedule input data as input and sets necessary headers such as content type and authentication information.

The terminal outputs the completed network request as the result of this step.

### Step 3

The terminal transmits the network request to the server through a communication network.

The server receives the network request as input via a network interface and passes the request to an application module.

The server extracts the schedule input data from the request payload and converts it into an internal object representation containing user identification, time fields, and activity descriptions.

The server outputs the internal schedule object as the result of this step.

### Step 4

The server receives the internal schedule object as input.

The server performs validation processing by applying parsing functions to each time field, checking conformity to a defined time format, and verifying that required fields, such as start times and end times, are present.

The server executes logical checks that compare numerical representations of times to ensure that start times precede end times and that intervals do not overlap in an invalid way.

The server outputs either a validation error description or a validated schedule object; when validation fails, error information is output, and when validation succeeds, the validated schedule object is output.

### Step 5

The server receives the validated schedule object as input when validation has succeeded.

The server maps content descriptions in the validated schedule object to standardized activity type codes using a classification table stored in a storage device.

The server generates a normalized schedule structure that associates each time interval with a standardized activity type and a link to user identification information.

The server outputs the normalized schedule structure as the result of this step.

### Step 6

The server receives the normalized schedule structure as input.

The server opens a connection to a database management system and converts the normalized schedule structure into one or more database records, each record including user identification, start time, end time, and activity type fields.

The server issues storage operations such as insertion or update commands to store the records in tables indexed by user identification and time intervals, and commits the transaction.

The server outputs confirmation of storage and a persistent schedule identifier as the result of this step.

### Step 7

The server receives the persistent schedule identifier and the normalized schedule structure as input.

The server constructs description information by concatenating human-readable time expressions and activity labels derived from the normalized schedule structure, thereby forming text that summarizes activity time periods and activity types for the user.

The server combines this description information with instruction information that specifies the required output from a generative AI model, and generates a prompt sentence such as “Based on the following schedule, please provide efficient task management suggestions. The user works from 09:00 to 18:00, has a lunch break from 12:00 to 13:00, and has a project meeting from 15:00 to 16:00.”

The server outputs the complete prompt sentence as the result of this step.

### Step 8

The server receives the prompt sentence as input.

The server embeds the prompt sentence into a request body defined by an interface specification of the generative AI model, and sets inference parameters such as maximum output length, randomness level, and decoding strategy.

The server generates a model invocation request containing the prompt sentence and the parameters, and prepares protocol headers needed by the external or internal inference apparatus.

The server outputs the prepared model invocation request as the result of this step.

### Step 9

The server transmits the model invocation request to the generative AI model hosted on an external or internal inference apparatus.

The generative AI model receives the prompt sentence as input and converts text tokens into embedding vectors; the model processes these vectors through multiple attention layers and feed-forward layers to compute probability distributions for subsequent tokens.

The generative AI model iteratively selects output tokens according to the computed distributions and the specified decoding parameters, thereby generating natural-language text that constitutes work management proposals aligned with the schedule context.

The generative AI model outputs the proposal text as response data and returns it to the server.

### Step 10

The server receives the response data containing proposal text from the generative AI model as input.

The server decodes the text from the response data and applies parsing logic that detects time expressions, activity references, and suggested actions by using pattern recognition rules and mapping tables.

The server aligns the detected time expressions with stored schedule intervals by converting both into numerical time ranges and matching overlapping or corresponding ranges, thereby producing time-period-specific proposal information associated with each interval.

The server outputs the structured time-period-specific proposal information as the result of this step.

### Step 11

The server receives the structured time-period-specific proposal information and the stored schedule records as input.

The server generates updated schedule data by inserting additional activity segments or modifying existing segments according to the proposed allocations, such as splitting a continuous interval into sub-intervals with different activity types.

The server records updated intervals and proposal-derived attributes, such as recommended task type and priority, into the database under a new schedule version associated with the same user identification, while preserving the original version.

The server outputs the updated schedule data and associated version information as the result of this step.

### Step 12

The server receives the time-period-specific proposal information and the updated schedule data as input.

The server constructs display models for a time-axis view and a list view by mapping each schedule interval and associated proposal text to visual positions and display attributes, such as color codes for activity types and labels for recommended actions.

The server converts the display models into display information and display control information that can be interpreted by the terminal's rendering logic, and includes both original schedule details and overlaid proposal descriptions.

The server outputs the display information and display control information as the result of this step.

### Step 13

The server receives the updated schedule data and user context as input.

The server determines which intervals in the updated schedule require notifications, such as upcoming deep-work periods or preparation times before meetings, by applying timing rules to the start times and durations.

The server generates notification information entries that include trigger times, short textual messages summarizing the proposed activity, and links to the relevant schedule version.

The server outputs the set of notification information entries as the result of this step.

### Step 14

The server transmits the display information, display control information, and notification information to the terminal.

The terminal receives these data sets as input from the communication network and passes them to a user interface module.

The terminal renders the time-axis display or list display using the display control information and schedules local alarms or alerts based on the notification information, thereby presenting the proposals and updated schedule visually and audibly to the user when appropriate.

The terminal outputs the final rendered interface and active notifications as the result of this step, and the user views the proposals and interacts with the updated schedule.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented scheduling systems typically accept user schedule information and generate simple reminders or static routing suggestions based on predefined rules. Such systems suffer from several technical limitations. First, they usually treat user schedule data as unstructured or weakly structured information, resulting in inefficient internal data handling and limited ability to generate complex operation plans for automated mobile bodies, such as autonomous vehicles. Second, when a machine learning model is employed, it is often directly fed with raw or semi-structured inputs without an optimized intermediate representation, which leads to suboptimal model utilization, increased processing overhead, and unreliable or inconsistent outputs. Third, many existing approaches lack an integrated mechanism for verifying temporal consistency and logical coherence between generated operation schedules and the original user schedule, thereby requiring additional manual checking or post-processing outside of a unified computational pipeline.

In addition, in systems that use generative artificial intelligence models, the prompt sentences supplied to the models are frequently ad hoc and not systematically derived from a normalized data representation. This causes variability in model performance, complicates reproducibility of results, and makes it difficult to adapt the system to diverse user schedules in a robust way. Furthermore, existing systems often fail to provide a cohesive feedback mechanism in which the outputs of the generative artificial intelligence model are automatically converted into structured operation schedule information, checked against scheduling constraints, and then transformed into notification data suitable for reliable delivery to user terminals with precise timing semantics.

From a computer technology standpoint, there is thus a need for a system that improves the internal data processing pipeline from schedule input to generative model invocation and back to user notification. Such a system should (i) standardize heterogeneous user schedule inputs into a structured, table-type representation, (ii) systematically construct prompt sentences and model inputs from that representation, (iii) automatically parse and validate the outputs of a generative artificial intelligence model into consistent operation schedule information for automated mobile bodies, and (iv) generate precise, machine-usable notification data for user devices. By doing so, the system can improve the efficiency, reliability, and technical robustness of computer-based scheduling and operation planning for automated mobility services.

The specific processing by the specific processing unit 290 of the data processing device 12 in Application Example 1 is realized by the following means.

The present invention provides a server comprising a processor configured to receive user behavior schedule information as input from a communication network, convert and format the behavior schedule information into structured, table-type data including at least time information and position information, generate, based on the structured data, a prompt sentence that describes in natural language a daily activity plan including the behavior schedule information, convert the prompt sentence and the structured data into input data in a format suitable for generation of an operation plan, and input the input data into a generative artificial intelligence model, analyze response data output from the generative artificial intelligence model and extract, as operation schedule information for an automated mobile body, at least an operation start time, an operation end time, a boarding point, and an alighting point, determine temporal consistency of the operation schedule information and consistency between the operation schedule information and the behavior schedule information, perform correction or adjustment of the operation schedule information based on a predetermined rule, and convert corrected or adjusted operation schedule information into notification data including time information for notifying a user device and transmit the notification data to the user device via the communication network. This enables a computer system to internally normalize user schedule inputs, systematically construct and supply optimized prompt sentences and structured features to a generative artificial intelligence model, automatically interpret and validate the model outputs as coherent operation schedules for automated mobile bodies, and deliver precise, time-sensitive notifications to user devices, thereby improving the technical efficiency, reliability, and consistency of computer-implemented scheduling and operation planning processes.

The term “behavior schedule information” refers to information indicating planned actions of a user in a time sequence, including at least planned start times, planned end times, and locations associated with respective activities.

The term “structured data” refers to data that is organized according to a predefined schema comprising multiple fields, such as time information and position information, so that the data can be processed in a deterministic manner by a computer program.

The term “table-type data” refers to structured data arranged in a tabular form, such as records and fields in a table, where each record represents an event or activity and each field represents an attribute such as a start time, an end time, or a location.

The term “prompt sentence” refers to a natural-language text string constructed from input data, which is supplied to a generative artificial intelligence model as an instruction or context for generating a desired output.

The term “generative artificial intelligence model” refers to a machine-learned computational model configured to generate output data, such as text or structured information, in response to input data including at least a prompt sentence and optionally additional features.

The term “input data in a format suitable for generation of an operation plan” refers to data that has been converted into a representation, including at least tokenized natural-language text and/or numerical feature vectors, that conforms to the input specification of the generative artificial intelligence model used to generate an operation plan.

The term “response data” refers to data output by the generative artificial intelligence model, including natural-language text and/or structured information representing a proposed operation plan.

The term “operation schedule information” refers to structured information that defines an operation plan for an automated mobile body, including at least an operation start time, an operation end time, a boarding point, and an alighting point for each movement section.

The term “automated mobile body” refers to a mobile apparatus, such as an autonomous vehicle or other self-driving transport unit, that is capable of moving without continuous manual control by a human operator.

The term “operation start time” refers to a time point indicating when the automated mobile body is scheduled to begin a particular movement section associated with transporting a user.

The term “operation end time” refers to a time point indicating when the automated mobile body is scheduled to complete a particular movement section associated with transporting a user.

The term “boarding point” refers to a location at which the user is scheduled to board the automated mobile body at the beginning of a movement section.

The term “alighting point” refers to a location at which the user is scheduled to leave the automated mobile body at the end of a movement section.

The term “temporal consistency” refers to a state in which times included in the operation schedule information satisfy predetermined logical relationships, including that an operation start time does not precede a corresponding previous operation end time by less than a predetermined margin.

The term “consistency between the operation schedule information and the behavior schedule information” refers to a state in which times and locations included in the operation schedule information are compatible with constraints indicated by the behavior schedule information, such as required arrival times and planned activity durations.

The term “predetermined rule” refers to a rule or set of rules defined in advance in a program or configuration, which specifies how to correct or adjust operation schedule information when inconsistencies or violations of constraints are detected.

The term “notification data” refers to data generated for transmission to a user device, including at least information indicating one or more future times and corresponding schedule events, for use in generating notifications or reminders.

The term “time information for notifying a user device” refers to information specifying one or more notification times, including times occurring a predetermined interval before scheduled departure times associated with movement sections of the operation schedule information.

The term “user device” refers to an electronic apparatus operated by a user, such as a portable communication terminal or a computing terminal having a display function and a communication function.

The term “display device” refers to a component or apparatus that presents visual information to a user, which may be part of a user device or a separate device, and is capable of displaying schedule information and notifications.

The term “communication network” refers to a network infrastructure, including wired and/or wireless links and communication protocols, that enables data transmission between the server and one or more user devices.

The term “server” refers to an information processing apparatus, including at least one processor and a memory, that executes one or more programs to perform reception, transformation, model invocation, schedule generation, validation, and notification processing as described in the claims.

The server, the terminal, and the user cooperate to implement embodiments of the present invention as described below.

The server includes at least one processor, a memory storing programs and models, a nonvolatile storage device, and a communication interface connected to a communication network. The server executes an operating system and middleware, and executes an application program that performs schedule normalization, prompt sentence generation, input encoding, generative AI inference, schedule post-processing, and notification data generation.

The server can be implemented on a general-purpose computing platform, such as a rack-mounted or blade-type information processing apparatus, or on a virtual machine or container instance provided in a cloud computing environment.

The terminal includes at least one processor, a memory, a display device, an input device such as a touch panel, and a communication module. The terminal executes an operating system for a portable communication terminal and a dedicated scheduling and mobility application. The terminal and the server communicate over a wired or wireless communication network using standard communication protocols. The user operates the terminal to input schedule information and to view operation schedules for an automated mobile body.

The server stores program modules including at least: a user schedule reception module, a data structuring module, a prompt generation module, an encoding module, a generative AI inference module, a schedule interpretation and validation module, and a notification generation module. The server additionally stores a trained generative AI model configured for schedule and operation plan generation, and optionally one or more auxiliary models such as a text parser or constraint checker.

The server receives behavior schedule information of the user from the terminal through the communication interface. The terminal converts user input into schedule records including at least start times, end times, and location identifiers. The server parses the received schedule records and converts them into structured data. The server, for example, uses a tabular representation in which each row corresponds to an event in the user's daily schedule and each column corresponds to an attribute such as event identifier, start time, end time, origin location, and destination location. The server stores this table-type structured data in memory in the form of a record array or a data frame.

The server transforms time strings into machine-usable values by converting them into date-time objects or numerical timestamps using a time conversion function. The server normalizes all time values to a common time standard, such as Coordinated Universal Time, or to a standardized local time zone, thereby reducing time conversion errors during later processing. The server normalizes location information by mapping user-entered location names to internal location identifiers or coordinate pairs, using a lookup table or a location resolution service. As a result, the server maintains a consistent, machine-optimized representation of the user's behavior schedule information.

The server generates a prompt sentence by reading each row of the table-type data and constructing a natural-language description of the corresponding activity. The server concatenates these descriptions into a single daily activity narrative. The server additionally inserts instructional text that directs the generative AI model to generate an operation schedule for an automated mobile body. One example of such a prompt sentence is:

“Given the following user schedule for today:
1) At 09:00, depart from Home and arrive at Office by 09:30.
2) At 12:00, depart from Office and arrive at Restaurant by 12:15.
3) At 17:00, depart from Office and arrive at Home by 17:30.

Using this information, generate an optimized autonomous vehicle operation schedule that minimizes waiting time and travel time, and ensures on-time arrival at each destination. Provide concrete departure and arrival times for each trip segment.”

The server may add further constraints and optimization goals to the prompt sentence, such as a request to avoid scheduling departures more than a certain interval earlier than requested, to respect maximum total travel time, or to provide buffer time between events. By constructing the prompt sentence directly from the normalized, table-type structured data, the server reduces variation and ambiguity in the content and format of the inputs supplied to the generative AI model. This improves reproducibility of the generated operation plans and reduces the need for heuristic tuning of the prompt content.

The server converts the prompt sentence and the structured data into input data in a format suitable for a generative AI model. In one embodiment, the generative AI model is a neural network-based sequence-to-sequence model having an encoder-decoder architecture with attention. The server tokenizes the prompt sentence into discrete tokens using a subword tokenizer such as a byte-pair-encoding-based tokenizer. The server maps each token to an integer index, creating a token sequence. The server then converts the sequence into numerical vectors using an embedding matrix stored in the model parameters. The server optionally adds positional encodings to each token vector so that the model can consider token order.

The server encodes additional structured schedule features, such as the number of events, estimated travel times between location pairs, and constraints on earliest and latest departure times, as numerical feature vectors. The server may append these feature vectors to the token embeddings or provide them through a secondary input path in the neural network architecture. For example, the server may project the structured features into the same dimensional space as the token embeddings and concatenate them to the encoder's context representation, thereby integrating symbolic schedule constraints directly into the generative AI model's internal state.

The server uses a generative AI model that may be implemented as a transformer network or another attention-based neural network. In a typical transformer implementation, the server executes multiple layers of multi-head self-attention and feedforward sublayers in the encoder stack and the decoder stack. The server uses a loss function such as cross-entropy during model training, and uses optimization algorithms such as stochastic gradient descent with momentum or adaptive methods during weight updates. The server trains the model in advance using pairs of input prompts and target operation schedules, possibly augmented with synthetic training data, and stores the learned weights in the server's storage.

During inference, the server loads the trained generative AI model into memory and maps it onto available computation hardware such as a graphics processing unit or a vector-capable central processing unit. The server executes a decoding algorithm, such as greedy decoding or beam search, to generate output token sequences from the model. The server calculates, at each decoding step, probability distributions over possible next tokens based on the decoder's internal state and attention over the encoded input. The server selects tokens according to those probabilities and iteratively builds an output sequence representing a proposed operation schedule.

The server receives response data from the generative AI model in the form of token sequences. The server decodes these token sequences back into natural-language text. The server then analyzes the text output to extract explicit operation schedule information. In one embodiment, the generative AI model is trained to output schedule information in a structured textual format such as lines of text each containing a time and a location. The server uses pattern-matching procedures and parsing rules to identify time expressions, location names, and their associations with particular movement segments.

The server maps the parsed time expressions back into numerical timestamps and maps location names to internal location identifiers, thereby reconstructing structured operation schedule information for the automated mobile body. The server creates or updates a table-type data structure in which each row corresponds to a movement segment of the automated mobile body and each column corresponds to attributes such as vehicle departure time, vehicle arrival time, boarding point, and alighting point. This structured representation enables the server to efficiently perform consistency checks and schedule optimizations using deterministic algorithms in addition to the generative AI model output.

The server determines temporal consistency of the operation schedule information by comparing the vehicle departure and arrival times of adjacent movement segments and verifying that they satisfy predetermined relationships, such as a requirement that the departure time of a movement segment must occur after the arrival time of the preceding movement segment plus a minimum handover interval. The server determines consistency between the operation schedule information and the original behavior schedule information by verifying, for example, that the arrival times of the automated mobile body enable the user to reach the locations specified in the behavior schedule by their required times.

The server applies predetermined rules to correct or adjust operation schedule information when inconsistencies are detected. Such rules can include, for example, shifting departure times forward or backward within allowable bounds indicated by the behavior schedule, adjusting buffer times between segments, or selecting alternative pickup or drop-off times from a discrete set of allowed options. The server uses algorithmic procedures, such as constrained optimization algorithms or greedy adjustment procedures, to modify the times in a manner that reduces violations of constraints while preserving as much as possible of the structure determined by the generative AI model. This hybrid process, in which generative AI output is systematically normalized and adjusted by deterministic constraint-checking algorithms, contributes to improved reliability and technical robustness of the overall system.

The server generates notification data based on the corrected or adjusted operation schedule information. The server calculates one or more notification times for each movement segment, such as a notification time set to a fixed interval before the scheduled departure time. The server includes these notification times in the notification data, together with identifiers of the relevant movement segments and summary text for display on the terminal.

The server transmits the notification data via the communication network to the terminal using communication protocols such as secure transport protocols and push notification mechanisms.

The terminal receives the notification data and stores it in its local memory. The terminal schedules local notifications using its internal timer and notification framework so that the user is informed, through visual and possibly auditory alerts on the display device, at appropriate times before each movement segment. The terminal displays visual representations of the operation schedule, such as lists of movement segments showing departure and arrival times and interactive maps showing boarding points and alighting points. The user can confirm, review, or modify the plan by interacting with the user interface, and the terminal transmits any modifications back to the server, which repeats the above-described generative and corrective processes based on the updated behavior schedule information.

In one concrete example, the user inputs, through the terminal, the following behavior schedule information: departure from a residence at 09:00 to reach a workplace by 09:30, departure from the workplace at 12:00 to reach a restaurant by 12:15, and departure from the workplace at 17:00 to reach the residence by 17:30. The terminal sends this information to the server. The server constructs a structured, table-type representation with three rows corresponding to the three activities. The server generates a prompt sentence similar to the example given above and appends additional instructions related to minimizing travel time and avoiding congested periods if possible. The server then encodes this prompt and the structured features into the input format for the generative AI model and triggers inference.

The server receives a textual operation schedule indicating, for example, that an automated mobile body should arrive at the residence at 08:50, arrive at the workplace at 09:10, arrive at the restaurant at 12:05, and so on. The server parses and normalizes these times, checks them against the user's behavior schedule constraints, adjusts minor inconsistencies, and generates notification data for the terminal, which notifies the user at each scheduled time.

The server thereby implements a data processing pipeline that improves computer technology in several ways. By converting heterogeneous behavior schedule information into normalized table-type structured data and by systematically generating prompt sentences and feature vectors from that data, the server reduces the dimensionality and noise of the input space supplied to the generative AI model. This contributes to more stable model behavior and reduces the number of token-level operations required per inference, which in turn reduces computational load and improves processing speed.

The server further improves accuracy of the operation schedules by leveraging a hybrid architecture in which the generative AI model proposes candidate schedules and deterministic validation and correction modules enforce temporal and behavioral constraints. This architecture reduces the occurrence of inconsistent or infeasible plans and reduces the need for manual correction, thereby lowering error rates compared to a purely rule-based system or a system that directly displays raw model outputs. The structured intermediate representations also facilitate caching and reuse of partial computations, which can reduce network and computation overhead when only portions of the user's schedule change.

The generative AI model itself is configured to use multi-head attention mechanisms to model interactions between different events in the daily schedule and between different movement segments of the automated mobile body. During training, the server prepares training data sets that include diverse patterns of behavior schedules, estimated travel durations, and target operation plans. The server uses data augmentation techniques such as time shifting, location sampling, and insertion of synthetic events to increase the variety of training instances. The server computes a loss function that includes components for sequence prediction error and for constraint satisfaction error, and uses backpropagation algorithms to update the neural network's weights. As a result, the model learns not only to copy patterns from training data but also to respect general temporal and structural constraints.

The server implements non-conventional processing steps beyond simple human task automation. Unlike a human scheduler or a straightforward rule engine, the server constructs machine-optimized representations that combine tokenized natural language and structured numerical features, and uses attention-based neural architectures to learn non-obvious patterns of buffer time allocation and route scheduling. The server's constraint-checking and correction modules are designed to work in tandem with the generative AI model, using specific predetermined rules and consistency metrics tailored to automated mobility scheduling, rather than generic calendar operations. This integrated design yields technical effects including reduced latency of schedule generation, improved accuracy of timing predictions under complex constraints, and reduced data transfer overhead due to compact structured representations passed between modules.

The server may be implemented in various embodiments. In one embodiment, the server uses a transformer-based generative AI model; in another embodiment, the server uses a recurrent neural network with an attention mechanism or a hybrid convolutional and recurrent model. In one embodiment, all modules are implemented as software processes running on a single physical server; in another embodiment, different modules such as the generative AI inference module and the schedule validation module execute on different machines connected by a high-speed internal network. In another embodiment, the terminal performs a portion of the preprocessing or visualization logic locally and communicates only summarized or compressed representations to the server, thereby reducing communication load.

The user, by interacting with the terminal, thus benefits from a system that not only automates generation of operation schedules for automated mobile bodies but also improves the underlying computer processing of time and location data, the encoding of such data for generative AI models, and the validation and delivery of time-critical notification information. This correlation between the specific data structures and algorithms used in the server and the achieved technical effects supports classification of the invention as an improvement in computer technology rather than as an abstract scheduling concept.

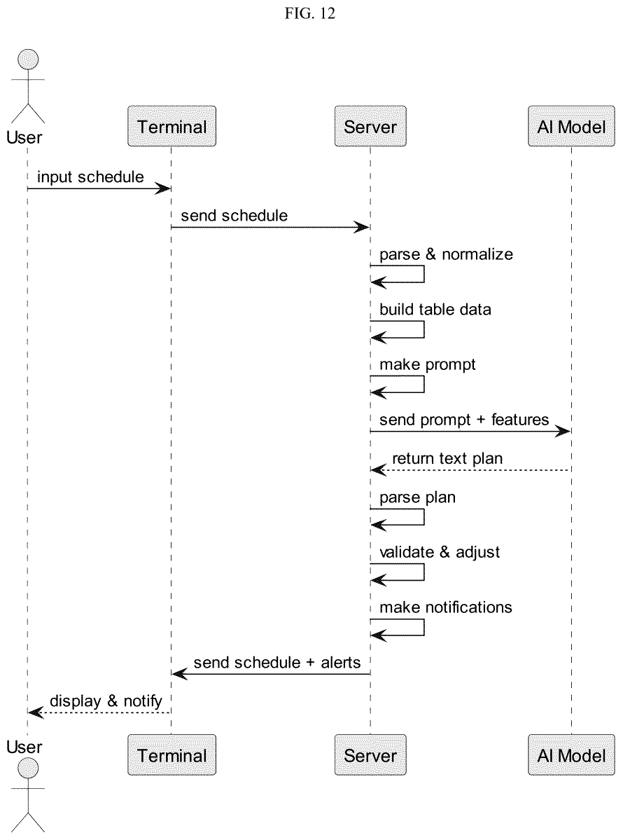

The following describes the processing flow using FIG. 12.

### Step 1

The user operates the terminal to start a scheduling application and input behavior schedule information. The input includes, for each planned activity, a start time, an end time or required arrival time, and a textual indication of an origin and a destination. The terminal accepts this input through a graphical user interface, checks that required fields are filled, and verifies formats such as time strings and location names. Based on the validated input, the terminal generates structured schedule records, for example internal objects each containing fields for time and location. The terminal then serializes these records into a message format such as JSON and outputs the serialized schedule data as a request, which is transmitted to the server over a communication network.

### Step 2

The server receives the serialized schedule data from the terminal through a communication interface. The input to this step is the schedule request message containing user-entered behavior schedule information encoded in a structured message format. The server parses the message using a decoder, extracts the individual schedule records, and validates required keys and data types. The server converts time strings into internal time representations, such as numerical timestamps, and converts textual location identifiers into normalized location identifiers or coordinate values using a lookup process. As a result of this data processing and format conversion, the server outputs normalized schedule records in an internal representation suitable for further computation.

### Step 3

The server converts the normalized schedule records into table-type structured data. The input to this step is the set of normalized records with explicit fields for times and locations. The server instantiates a tabular data structure in memory, such as an array of rows where each row corresponds to one activity and each column corresponds to attributes including event identifier, start time, end time, origin location identifier, and destination location identifier. The server populates the table with values from the normalized records and computes additional attributes, such as estimated travel time between each origin-destination pair using pre-stored distance or time matrices. By arranging the data in a table and computing these derived attributes, the server outputs structured, table-type data that enables efficient indexing, aggregation, and subsequent feature extraction.

### Step 4

The server generates a prompt sentence based on the table-type structured data. The input to this step is the table containing rows for each scheduled activity. The server iterates over the rows, and for each row, the server formats a textual description including the time and location attributes. The server concatenates these descriptions into a coherent natural-language narrative of the user's daily schedule and adds instruction text specifying optimization goals and constraints for generating an operation plan. Through string concatenation and insertion of parameter values from the table, the server outputs a complete prompt sentence, such as:

“Given the following user schedule for today:
1) At 09:00, depart from Home and arrive at Office by 09:30.
2) At 12:00, depart from Office and arrive at Restaurant by 12:15.
3) At 17:00, depart from Office and arrive at Home by 17:30.

Using this information, generate an optimized autonomous vehicle operation schedule that minimizes waiting time and travel time, and ensures on-time arrival at each destination. Provide concrete departure and arrival times for each trip segment.”

### Step 5

The server constructs model input data by encoding the prompt sentence and structured features. The input to this step is the prompt sentence and the table-type structured data. The server tokenizes the prompt sentence into discrete tokens using a subword tokenization algorithm, maps each token to an integer index, and then uses an embedding matrix to convert each index into a dense vector. The server computes positional encodings for each token position and adds them to the embedding vectors, generating a sequence of input token embeddings. In parallel, the server extracts numerical features from the structured table, such as the count of events, normalized time intervals, and encoded origin-destination pairs, and arranges them into feature vectors. The server normalizes and scales these numerical features and, if configured, concatenates or otherwise fuses them with the token embedding representations. The output of this step is a set of tensors representing the encoded text and numerical features, formatted according to the input specification of the generative AI model.

### Step 6

The server performs inference using the generative AI model to generate an operation schedule. The input to this step is the set of encoded tensors representing the prompt sentence and the associated features. The server provides these tensors to a generative AI model, such as a transformer-based sequence-to-sequence model stored in the server's memory. The server executes the model's forward pass by computing multi-head attention operations, linear transformations, activation functions, and layer normalizations across multiple layers, thereby producing hidden representations and probability distributions over possible output tokens at each decoding step. The server applies a decoding strategy, such as greedy decoding or beam search, to iteratively select output tokens and assemble them into output token sequences. The output of this step is one or more token sequences corresponding to a proposed operation schedule expressed in a textual or structured textual format.

### Step 7

The server decodes and interprets the model output to obtain structured operation schedule information. The input to this step is the output token sequences from the generative AI model. The server converts token indices back into text tokens using the same tokenizer dictionary and joins tokens into text strings. The server then applies parsing rules and pattern-matching procedures to detect time expressions, location names, and markers that indicate segment boundaries. For each identified movement segment, the server extracts a departure time, an arrival time, a boarding location, and an alighting location, and maps these values back into the internal time and location identifier formats. The server inserts these values into a new table-type data structure that represents the automated mobile body's operation schedule. The output of this step is structured operation schedule information organized in rows corresponding to movement segments and columns corresponding to schedule attributes.

### Step 8

The server validates consistency of the operation schedule information and adjusts it if necessary. The input to this step is the operation schedule table output from the previous step and the original user behavior schedule structured data. The server compares, for each movement segment, the scheduled departure and arrival times against the required times and durations in the behavior schedule, and verifies that each arrival time allows the user to participate in the corresponding planned activity. The server also checks that the time between consecutive segments meets minimum transition and buffer requirements. When inconsistencies or violations are detected, the server applies predetermined rules, such as shifting times within allowed windows or inserting buffer intervals, and recomputes affected times. Through these calculations and updates on the table entries, the server outputs a corrected or adjusted operation schedule table that satisfies temporal and behavioral constraints.

### Step 9

The server generates notification data based on the corrected operation schedule. The input to this step is the corrected operation schedule table containing departure and arrival times and location identifiers for each movement segment. The server determines notification times by subtracting a predetermined lead time from each departure time or by applying other timing policies. The server creates notification records that include, for each movement segment, the notification time, a textual summary of the segment, and references to the corresponding schedule entries. The server formats these notification records into a message format suitable for transmission to the terminal, such as a compact structured representation including both machine-readable fields and human-readable text. The output of this step is a notification message containing all notification records for the relevant schedule.

### Step 10

The server transmits the notification data to the terminal, and the terminal presents it to the user. The input to this step is the notification message generated by the server. The server sends the message through a communication interface using network protocols and, if necessary, a push notification service. The terminal receives the message, decodes the notification records, and stores them in local memory. The terminal configures local timers or scheduling mechanisms to trigger alerts at the indicated notification times. The terminal then outputs visual information on the display device, presenting the user with the upcoming movement segments, departure times, arrival times, and locations. By using the stored notification data and the device's timing functions, the terminal produces user-facing notifications and schedule views, and outputs confirmation events back to the user in response to user interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional schedule management systems merely record and display user schedule information, and at most provide simple time-based reminders. Such systems are not configured to analyze long continuous sedentary intervals in a day, nor to dynamically generate exercise proposals that are context-aware and tailored to the user's actual schedule and preferences. As a result, existing systems fail to effectively assist users in maintaining physical health during prolonged desk work or meeting periods.

Furthermore, even when external content services suggest exercise routines, such suggestions are typically static, manually curated, and not integrated with the user's concrete schedule data. These approaches do not leverage advanced machine learning models to synthesize exercise timing and content based on structured behavior schedule information, nor do they utilize feedback loops in which user execution status and evaluations are fed back into the content generation process. Consequently, conventional architectures lack adaptivity and do not improve over time in response to individual user behavior.

From a computer-technology standpoint, there is no standardized mechanism for transforming heterogeneous schedule data into a machine-usable representation suitable for generative models, generating prompt sentences that encode temporal constraints and user preferences, enforcing output in a machine-readable format, and automatically converting that output into notification events on terminal devices. In many deployments, developers are required to implement ad hoc integrations between schedule databases and content services, which leads to increased processing overhead, fragile interfaces, and limited scalability.

Additionally, typical systems do not provide a structured, computer-implemented pipeline that: (i) normalizes raw schedule information into structured time and behavior-type information, (ii) detects continuous static-state intervals requiring intervention, (iii) constructs rich prompt sentences with explicit constraints for a generative AI model, (iv) parses machine-readable model output, and (v) automatically and safely registers multiple notification events on terminal devices. This absence of an end-to-end architecture limits the ability of computing systems to automatically generate and deliver optimized, personalized exercise guidance without manual rule maintenance.

Accordingly, there is a need for an improved computer-implemented system and method that can efficiently process user schedule information, automatically detect high-risk sedentary intervals, generate constraint-aware prompt sentences for a generative AI model, receive and interpret machine-readable proposals for exercise time zones and contents, and automatically schedule notifications on terminal devices. Such a system should further be capable of incorporating user feedback into subsequent prompt sentences, thereby improving the quality and personalization of generated proposals over time and enhancing the overall functioning of the computer system in health-support applications.

The specific processing by the specific processing unit 290 of the data processing device 12 in Example 2 is realized by the following means.

The present invention provides a server comprising a processor configured to receive behavior schedule information of a user from a terminal device and store the behavior schedule information as structured information including time information and behavior type information, to analyze the structured information so as to detect a continuous static-state interval in which the user is expected to remain substantially sedentary for at least a predetermined period and to calculate a candidate exercise execution time zone corresponding to the continuous static-state interval, to generate a prompt sentence in a natural language based on the behavior schedule information and the candidate exercise execution time zone, the prompt sentence including constraint conditions comprising preference information of the user and exercise condition information, to input the prompt sentence to a generative AI model so as to instruct the generative AI model to generate a proposal of an exercise content and an exercise time zone corresponding to the candidate exercise execution time zone, to receive, from the generative AI model, proposal information in a machine-readable data format having a predetermined format, to parse the machine-readable data format so as to extract exercise time zone information and exercise content information as exercise proposal information, to adjust the exercise proposal information so as to be consistent with the behavior schedule information and generate notification information including the exercise time zone information and the exercise content information, to transmit the notification information to the terminal device, and to acquire, from the terminal device, execution status information or evaluation information of the user with respect to the proposal information and include the execution status information or the evaluation information in a subsequent prompt sentence so as to adaptively update, for each user, the proposal of the exercise time zone and the exercise content generated by the generative AI model. This enables a computer system to automatically transform raw schedule data into structured temporal constraints, to efficiently coordinate with a generative AI model through constraint-rich prompt sentences and machine-readable outputs, to reliably register and deliver multiple health-related notifications on terminal devices without manual rule configuration, and to iteratively improve the personalization and effectiveness of generated exercise guidance based on user feedback, thereby improving the functioning of the computer system in providing context-aware health support.

The term “behavior schedule information” refers to information indicating planned activities of a user over time, including at least time-related information and activity-type information for each planned activity during a day or another time period.

The term “terminal device” refers to an electronic apparatus operated by a user, such as a portable communication device, a wearable device, or a general-purpose computing device, which is configured to transmit information to and receive information from a server.

The term “structured information” refers to data that is organized according to a predefined schema, including fields such as time information and behavior type information, so that the data can be programmatically analyzed and processed by a computing device.

The term “time information” refers to data representing a point in time or a time interval, such as a start time, an end time, or a duration, expressed in a format that can be interpreted and compared by a computing device.

The term “behavior type information” refers to data indicating a category or type of user activity, such as desk work, meeting, break, or movement, which is associated with a corresponding time interval in the behavior schedule information.

The term “continuous static-state interval” refers to a time interval, derived from the behavior schedule information, during which the user is predicted to remain in a substantially sedentary or low-movement state for at least a predetermined duration.

The term “candidate exercise execution time zone” refers to a time period calculated based on the continuous static-state interval and other constraints, during which execution of a physical exercise by the user is recommended.

The term “preference information” refers to information representing user-specific likes, dislikes, or tendencies regarding exercise characteristics, such as preferred exercise types, preferred intensity levels, or acceptable exercise durations.

The term “exercise condition information” refers to constraint information regarding execution of exercises, including at least one of maximum exercise duration, allowed exercise locations, required intensity levels, or equipment usage conditions.

The term “prompt sentence” refers to a natural-language text generated by the server and input to a generative AI model, the text specifying context, constraints, and requested output format so as to guide the generative AI model in generating proposal information.

The term “generative AI model” refers to a machine learning model configured to generate textual or structured output in response to an input prompt sentence, the model being implemented, for example, as a large language model executing on one or more computing devices.

The term “proposal information” refers to information output from the generative AI model in response to the prompt sentence, the information including at least an exercise content and an exercise time zone corresponding to the candidate exercise execution time zone.

The term “exercise time zone information” refers to information indicating a proposed point in time or time interval for executing an exercise, such as a clock time or a period expressed in a machine-readable format.

The term “exercise content information” refers to information describing at least one type of physical activity, movement, or posture to be executed by the user, including instructions or descriptions for performing the exercise.

The term “exercise proposal information” refers to a subset of the proposal information that includes at least the exercise time zone information and the exercise content information to be used for notification to the user.

The term “notification information” refers to information generated by the server for delivery to the terminal device, including at least the exercise time zone information and the exercise content information, and optionally including display texts, notification identifiers, or alert parameters.

The term “machine-readable data format” refers to a data representation, such as a structured text format or binary format, defined by a predetermined schema so that the data can be programmatically parsed, validated, and processed by a computing device without human interpretation.

The term “notification event” refers to an event registered on the terminal device that is configured to trigger output of a notification, such as a visual alert, an auditory alert, or a vibration, at a time corresponding to associated exercise time zone information.

The term “execution status information” refers to information indicating whether and how the user has acted in response to a proposal, including at least one of completion status, partial completion, or non-execution of a proposed exercise.

The term “evaluation information” refers to feedback information provided by the user regarding the proposal information or the executed exercise, including at least one of subjective ratings, comments, or qualitative assessments such as “too intense” or “too easy.”

In one embodiment, a server, one or more terminal devices, and a user cooperate to implement the invention. The server executes a program on general-purpose computing hardware such as a multi-core processor and a memory subsystem. The server runs an operating system, such as a general-purpose server operating system, and application software implemented in a programming language such as Python or Java. The server hosts a network-facing application, for example a web service implemented using a web framework.

The terminal executes a client application on user equipment such as a smartphone, a tablet, a wearable device, or a personal computer. The terminal runs a platform-specific operating system and a graphical user interface framework, and communicates with the server via a communication network such as the Internet using a secure protocol such as HTTPS.

The server stores behavior schedule information, user preference information, and exercise condition information in a data storage device such as a relational database management system. The server represents behavior schedule information as structured information including fields such as user identifier, date, start time, end time, and behavior type. The server uses data structures such as arrays, lists, and records to store and manipulate this structured information in memory. The server converts time strings into numerical values, such as minutes from midnight, and stores such values for efficient computation and comparison.

The terminal acquires behavior schedule information by presenting input screens to the user. The terminal displays user interface components such as text fields, time pickers, and selection controls to receive entries representing desk work intervals, meeting intervals, break intervals, and other activities. The terminal converts the user's input into structured information and transmits the structured information to the server via the communication network. The terminal may also acquire user preference information, such as preferred exercise types and preferred intensity levels, and transmit such information to the server.

The server analyzes the structured behavior schedule information to detect continuous static-state intervals. The server defines static-state intervals as time intervals in which the behavior type corresponds to sedentary activities such as desk work or meetings. The server converts each event's start time and end time into numerical values and sorts the events in chronological order. The server merges adjacent or overlapping sedentary events into a continuous interval and calculates the duration of the merged interval by subtracting the earliest start time from the latest end time. When the duration exceeds a predetermined threshold, such as sixty minutes, the server classifies the interval as a continuous static-state interval and registers that interval as a candidate for exercise insertion.

The server calculates candidate exercise execution time zones within or near the continuous static-state interval. The server uses algorithms that consider the location of meetings and other fixed events. For example, when the server detects that a meeting starts at a particular time, the server calculates a candidate exercise execution time zone immediately before or after the meeting by subtracting or adding a configurable offset, such as five minutes, from the meeting start or end time. The server checks whether the calculated candidate exercise execution time zone overlaps with other events and adjusts the time zone boundaries so as to avoid conflicts. The server may calculate multiple candidate exercise execution time zones within a single continuous static-state interval by dividing the interval into segments based on a target maximum sedentary period.

The server generates a prompt sentence in a natural language for a generative AI model based on the behavior schedule information, the candidate exercise execution time zones, the user preference information, and the exercise condition information. The server uses text templates and string concatenation operations to assemble a prompt sentence including a summary of the user's schedule, explicit constraints on exercise duration, type, and intensity, and a request for a machine-readable output format. For example, the server generates a prompt sentence such as: “User's schedule: desk work from 9:00 a.m. to 5:00 p.m., with an online meeting from 3:00 p.m. to 4:00 p.m. The user prefers gentle stretching exercises that last 5-10 minutes and can be done near a desk in office clothes. Please propose 2-3 optimal exercise time slots and concrete exercise instructions, focusing on counteracting long sitting periods. Return the result in JSON with an array ‘plans’, each element having fields ‘time’, ‘duration_minutes’, and ‘exercise_description’.”

The server may generate alternative prompt sentences that request different numbers of plans, different intensity levels, or different output structures. For example, the server may generate a prompt sentence such as: “User's schedule: desk work from 8:30 a.m. to 6:00 p.m., with meetings from 10:00 a.m. to 10:30 a.m. and from 4:00 p.m. to 4:30 p.m. The user reported that upper-body stretches felt good and that squats were too intense. Please propose 3 gentle stretching exercises (5-8 minutes each) at suitable times during the day. Focus on neck, shoulders, and upper back. Return the result in JSON with ‘time’, ‘duration_minutes’, and ‘exercise_description’.”

The server inputs the prompt sentence to a generative AI model. In one embodiment, the server accesses a generative AI model implemented as a transformer-based neural network, such as a large language model executing on a remote inference service. The generative AI model comprises a token embedding layer, a plurality of self-attention layers, and an output projection layer. Each self-attention layer computes attention weights between tokens using a scaled dot-product operation and updates token representations through weighted sums. The generative AI model is parameterized by a large number of weight values, and the model has been pre-trained on a large corpus of text using an unsupervised learning objective such as next-token prediction. The server transmits the prompt sentence to the generative AI model via an application programming interface, and the generative AI model generates a sequence of output tokens corresponding to the proposal information.

The server configures the generative AI model call with parameters such as temperature, maximum number of output tokens, and decoding strategy (e.g., greedy decoding or beam search) to trade off determinism and diversity in the generated proposals. The server instructs the generative AI model, through the prompt sentence, to output the proposal information in a machine-readable format with specific field names and structures. This machine-readable format allows the server to parse the proposal information reliably without heuristic natural-language parsing. The server thereby reduces processing time and improves robustness by avoiding ambiguous free-form outputs.

In one embodiment, the generative AI model is trained or fine-tuned using supervised learning on a dataset of schedule-exercise pairings. The dataset includes structured schedule examples and corresponding exercise proposals, encoded as prompt-response pairs. The generative AI model is optimized using a loss function such as cross-entropy loss over the next-token predictions. The training procedure adjusts the model's weight parameters by computing gradients via backpropagation and updating the weights using an optimization algorithm such as stochastic gradient descent or an adaptive method. The training set may be augmented with synthetic variations generated by perturbing schedule times, inserting randomized but consistent exercise plans, or modifying wording, thereby improving generalization and robustness. The server benefits from this training by obtaining a model that can infer non-trivial relationships between sedentary intervals, user preferences, and feasible exercise plans.

The server receives the generated proposal information from the generative AI model. The server employs a parser module to analyze the machine-readable data format specified in the prompt sentence. The parser validates that required fields such as “time”, “duration_minutes”, and “exercise_description” are present and correctly typed. The server converts time strings in the proposal information into numerical values and checks that proposed exercise time zones fall within the user's working hours or other permitted time ranges. The server also checks that the proposed exercises do not conflict with non-interruptible events such as meetings marked as mandatory. In case of conflicts, the server shifts or prunes exercise proposals according to pre-defined adjustment rules.

The server generates notification information that includes the validated exercise time zone information and exercise content information. The server formats notification information in a representation suitable for the terminal, such as a list of notification events each containing a trigger time, a concise message, and optional metadata for notification behavior such as vibration or sound. The server transmits the notification information to the terminal via the communication network.

The terminal receives the notification information from the server and registers notification events with an operating system notification subsystem. The terminal converts the trigger times into local time zone-aware timestamp values and requests that the operating system deliver alerts at those times. The terminal may store the exercise content information in local storage for later display. At each trigger time, the terminal outputs a notification to the user using a visual alert such as a popup, banner, or lock-screen message, and optionally an auditory alert such as a tone or vibration. The terminal may display detailed instructions to guide the user through the exercise, including textual descriptions and, in some embodiments, images or simple animations.

The user receives the notification and performs the proposed exercise. After performing or skipping the exercise, the user may provide feedback via the terminal. The terminal presents options such as “Completed”, “Skipped”, “Too easy”, or “Too intense” and transmits execution status information and evaluation information to the server. The server stores this information in association with the schedule and the corresponding exercise proposal. In subsequent operations, the server incorporates the stored feedback into new prompt sentences. For example, the server may add a clause such as “The user previously reported that squats were too intense and prefers seated exercises” to the prompt sentence. By doing so, the server guides the generative AI model to produce proposals that better match the user's capabilities and preferences.

The server improves computational efficiency and accuracy by using specific data structures and algorithms for integration with the generative AI model. The structured behavior schedule information is stored in normalized relational tables with indexes on user identifier and time fields, enabling rapid retrieval and chronological sorting. The detection of continuous static-state intervals is implemented as a linear scan with constant-time operations per event, enabling the system to process large schedules with low computational complexity. The server uses batched communication with the generative AI model when multiple users'schedules are processed, aggregating multiple prompt sentences into a single request when supported by the inference service. This reduces communication overhead and improves throughput.

The generative AI model is configured to output explicit delimiters and field names in the machine-readable format, minimizing the need for natural-language parsing. This reduces parsing errors and eliminates reliance on ambiguous textual patterns. The server further uses constraint checking and post-processing rules to correct or reject inconsistent model outputs. As a result, the system achieves higher overall reliability and reduces manual rule maintenance and error handling.

The system provides technical improvements over conventional approaches. The automatic detection of continuous static-state intervals prevents exhaustive manual configuration of rules for each possible schedule pattern, thereby reducing computational load and complexity. The explicit generation and enforcement of constraint-rich prompt sentences allow the generative AI model to operate as a specialized co-processor for schedule-aware exercise planning, freeing the server from having to implement and maintain a large number of handcrafted rules. The machine-readable output format, combined with structured parsing and validation, improves data management and reduces the likelihood of malformed or incomplete notifications being delivered to the terminal.

By integrating schedule analysis, prompt sentence generation, constrained generative AI processing, and automatic notification registration, the server improves the functioning of the underlying computer system. The system reduces round-trip latency by avoiding iterative, trial-and-error interactions with the generative AI model; instead, the first prompt includes rich constraints and formatting instructions. The system improves accuracy of exercise timing and content matching by combining deterministic schedule analysis with probabilistic generative modeling. The system also reduces communication bandwidth by sending concise structured proposals rather than verbose unstructured text between server and terminal.

The system employs processing rules that differ from conventional human planning behavior. The server does not simply emulate a human manually scanning a calendar; instead, the server detects static-state patterns using numerical thresholds and interval-merging algorithms, applies programmatic constraints, and delegates high-level content generation to a trained neural network that has encoded non-obvious correlations in its weight parameters.

The neural network generates proposals that are conditioned on complex combinations of schedule structure, user preferences, and feedback, which would be difficult to maintain using human-authored rules alone.

Variations of the embodiment are possible. In one variation, the generative AI model executes on the same physical server as the schedule analysis module, using a local accelerator such as a graphics processor. In another variation, the terminal performs part of the schedule analysis, for example pre-calculating static-state intervals and transmitting those intervals to the server, thereby reducing server load. In another variation, the system supports multiple behavioral domains beyond physical exercise, such as cognitive breaks or hydration reminders, by extending behavior type information and exercise condition information and by adjusting the prompt sentence templates accordingly.

In another embodiment, the server uses different neural network architectures. For example, the generative AI model may incorporate encoder-decoder structures, mixture-of-experts layers, or adapter modules fine-tuned on domain-specific datasets. The training regime may employ reinforcement learning from human feedback, where human evaluators or logged user feedback rate generated exercise plans, and the model's policy is updated using a reward model. The server can integrate such improved models without changing the external prompt sentence and output parsing pipeline, thus preserving the technical benefits of the system architecture.

In further embodiments, the server compresses and caches frequently requested proposal patterns. For example, when many users share similar schedules, the server may store canonical exercise plans and reuse them, only invoking the generative AI model for atypical or complex cases. This reduces inference calls, improves response time, and decreases computational resource usage. The server may also adjust the frequency and length of prompt sentences in response to system load, for example by simplifying constraints while maintaining the required machine-readable output structure.

Through these embodiments and variations, the server, terminal, and user cooperate to implement a computer-implemented system that uses schedule-aware analysis, structured prompt sentence construction, and constrained generative AI processing to generate, refine, and deliver personalized exercise guidance. The system thereby achieves technical effects including improved processing efficiency, enhanced accuracy and robustness of generated plans, reduced communication overhead, and improved management of structured health-support data across networked computing devices.

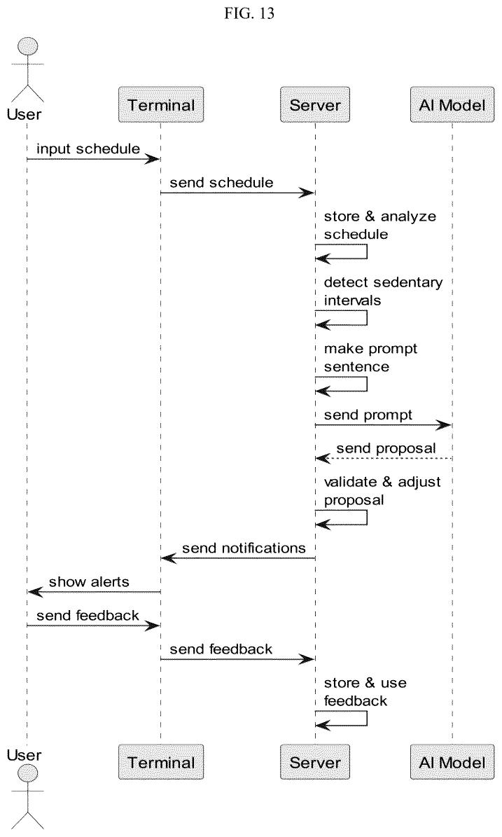

The following describes the processing flow using FIG. 13.

### Step 1

User operates the terminal to input behavior schedule information.

User views an input screen on the terminal and enters planned activities such as desk work periods and meeting periods by specifying start times, end times, and activity types. The input is free-form user actions (taps and text entries), and the output is a set of schedule entries displayed on the terminal screen.

### Step 2

Terminal converts the user input into structured behavior schedule information and transmits it to the server.

Terminal receives raw UI input as strings and selected options, validates that each start time precedes its corresponding end time, and normalizes date and time values into a consistent format. As input, the terminal uses the user-entered text and UI selections; as output, the terminal produces a structured record set including a user identifier, a date, start and end times, and behavior type labels. Terminal encodes these records into a structured data format and sends the encoded data to the server over a network using a secure communication protocol.

### Step 3

Server receives the behavior schedule information and stores it as structured information in a data storage device.

Server accepts a network request containing the structured schedule data as input, parses the encoded data into in-memory objects, and performs schema validation to ensure that all required fields are present. Server then maps the parsed objects into relational records and writes them into database tables indexed by user identifier and time. The output of this step is a persistent, queryable schedule dataset stored in the database.

### Step 4

Server normalizes time information and sorts schedule events.

Server reads schedule records for a given user and day from the database as input and converts each human-readable time string into a numerical representation, such as minutes from midnight, using arithmetic on hours and minutes. Server then places the events into an in-memory list and sorts the list in ascending order of start time using a comparison-based sorting algorithm. The output is an ordered event sequence with normalized numerical time fields that can be processed efficiently in later steps.

### Step 5

Server detects continuous static-state intervals from the sorted schedule events.

Server takes the ordered event sequence as input and scans it sequentially, merging consecutive events whose behavior type corresponds to sedentary activities, such as desk work or meetings. For each merged segment, server computes the duration by subtracting the earliest start time from the latest end time. Server compares the duration with a predefined threshold and classifies segments exceeding the threshold as continuous static-state intervals.

The output of this computation is a list of continuous static-state intervals represented by start times, end times, and associated behavior context.

### Step 6

Server calculates candidate exercise execution time zones based on the continuous static-state intervals.

Server uses the list of continuous static-state intervals as input and applies rule-based computations to determine where exercise breaks should occur. For example, server may compute offsets from meeting start and end times or subdivide long static-state intervals into equal or bounded-length subsegments. Server checks each candidate time zone against existing schedule events to avoid overlap by comparing numerical time ranges and adjusting boundaries if conflicts are detected. The output is a list of candidate exercise execution time zones, each annotated with a recommended duration.

### Step 7

Server retrieves user preference information and exercise condition information and combines them with the candidate time zones.

Server queries the database for a given user identifier to obtain stored preference records and condition records as input. Server reads fields such as preferred exercise types, maximum exercise duration, disallowed movement types, and target intensity. Server then combines these records with the candidate exercise execution time zones by attaching preference and condition attributes to each candidate. The output is an enriched candidate list that contains time zone data and associated constraints.

### Step 8

Server generates a natural-language schedule summary from the structured behavior schedule information.

Server takes the normalized and sorted schedule events as input and converts them into a human-readable description by mapping numerical times back to formatted time strings and concatenating activity descriptions. Server uses string templates and formatting rules to produce a textual summary such as “desk work from 9:00 a.m. to 5:00 p.m., with an online meeting from 3:00 p.m. to 4:00 p.m.” The output is a schedule summary sentence that will be included in a prompt sentence.

### Step 9

Server constructs a prompt sentence including schedule summary, candidate time zones, user preferences, and exercise conditions.

Server uses as input the schedule summary sentence, the enriched candidate time zones, and the user preference and condition attributes. Server integrates these elements into a natural-language prompt sentence by embedding the data into parameterized text templates and appending explicit instructions regarding desired output structure. For example, server may generate:

“User's schedule: desk work from 9:00 a.m. to 5:00 p.m., with an online meeting from 3:00 p.m. to 4:00 p.m. The user prefers gentle stretching exercises that last 5-10 minutes and can be done near a desk in office clothes. Please propose 2-3 optimal exercise time slots and concrete exercise instructions, focusing on counteracting long sitting periods. Return the result in JSON with an array ‘plans’, each element having fields ‘time’, ‘duration_minutes’, and ‘exercise_description’.”

The output of this step is a fully formed prompt sentence ready for submission to a generative AI model.

### Step 10

Server transmits the prompt sentence to the generative AI model and configures inference parameters.

Server uses the prompt sentence as input to an application programming interface of the generative AI model. Server sets inference parameters such as temperature, maximum token count, and decoding strategy, and sends a request containing the prompt and these parameters over a network connection to a model-serving component. The output of this step is a pending inference request managed by the model-serving infrastructure.

### Step 11

Generative AI model processes the prompt sentence and generates proposal information.

Server triggers execution of a generative AI model that internally applies tokenization to the prompt sentence, converts tokens into embedding vectors, and propagates the vectors through multiple transformer layers that perform self-attention and feed-forward operations. The model uses learned weight matrices and non-linear activation functions to compute context-dependent token representations and predicts output tokens sequentially using a probability distribution over a vocabulary. As input, the model receives tokenized prompt data; as output, the model produces a sequence of tokens representing machine-readable proposal information, such as a structured plan containing exercise times, durations, and descriptions.

### Step 12

Server receives the proposal information from the generative AI model and parses the machine-readable data.

Server obtains the generated text from the model as input and applies a parser that recognizes the specified machine-readable structure. Server validates the syntax, checks for the presence of required fields, and converts textual numbers into numerical values for time and duration. Server then constructs in-memory data objects representing each exercise plan entry. The output is a validated list of exercise proposal entries containing exercise time zone information and exercise content information.

### Step 13

Server validates and adjusts the exercise proposal entries against the original behavior schedule information.

Server uses as input the list of proposal entries and the original normalized schedule events. Server compares each proposed exercise time interval with scheduled events by checking for overlaps using numerical time comparisons. When an overlap with a non-interruptible event is detected, server either shifts the exercise time by a calculated offset or removes the conflicting entry according to predefined priority rules. Server also enforces global constraints, such as maximum number of exercises per day or maximum cumulative exercise time. The output of this step is a refined list of exercise proposals consistent with the behavior schedule.

### Step 14

Server generates notification information from the refined exercise proposal entries.

Server takes the refined proposals as input and formats user-facing notification messages. Server converts numerical time values into localized time strings and composes concise instructions such as “At 2:55 p.m., before your 3:00 p.m. meeting, perform upper back and chest stretches for 5 minutes.” Server packages each message with its corresponding trigger time and optional metadata into a notification information structure. The output is a notification payload ready to be transmitted to the terminal.

### Step 15

Server transmits the notification information to the terminal.

Server sends the notification payload as input to a network communication module that encodes the data and transmits it over a secure channel to the terminal. The output is a network message received by the terminal that contains the list of notification events and associated message texts.

### Step 16

Terminal receives the notification information and registers notification events with the operating system.

Terminal uses the notification payload as input and parses it into a list of notification items. Terminal converts each trigger time into a system-recognized timestamp and calls operating system notification APIs to schedule local notifications. Terminal may write the notification entries into local persistent storage for tracking. The output is a set of registered notification events that will cause alerts at the designated times.

### Step 17

Terminal outputs notifications to the user at the scheduled exercise times.

Terminal monitors system time and, when a registered notification event becomes due, the operating system passes the event to the terminal application as input. Terminal retrieves the corresponding exercise content information and displays a visual alert, such as a banner or dialog, and may also play a sound or trigger vibration. The output is a visible and optionally audible notification presented to the user with specific instructions.

### Step 18

User responds to the notification and performs or skips the proposed exercise.

User receives the notification as input and decides whether to follow the exercise instructions. User may perform the described movements or ignore the notification. User then optionally interacts with the terminal by selecting a response such as “Completed”, “Skipped”, or a qualitative evaluation of exercise intensity. The output is user feedback data entered into the terminal.

### Step 19

Terminal transmits execution status information and evaluation information to the server.

Terminal converts the user's feedback selections into structured status and evaluation records as input to a network request. Terminal sends these records, associated with exercise identifiers and timestamps, to the server over the network. The output is a feedback message reaching the server that describes how the user reacted to each exercise proposal.

### Step 20

Server stores the feedback information and incorporates it into subsequent prompt sentences.

Server receives the feedback data as input, validates its structure, and writes it into database tables linked to user identifiers and proposal identifiers. When the server later generates new prompt sentences, server queries the stored feedback and computes summary features such as preferred exercise regions, historically skipped exercises, and typical completion patterns. Server then appends sentences to new prompt sentences describing this feedback, for example “The user previously reported that upper-body stretches felt good and that squats were too intense.” The output is an updated prompt sentence that reflects the user's historical behavior and evaluations, which guides the generative AI model to generate more suitable future proposals.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented scheduling and recommendation systems primarily treat a user's schedule as static data and generate rule-based reminders or generic task lists. Such systems typically do not integrate heterogeneous, time-varying inputs such as emotional state, biological state, and external machine operation logs into a unified computation pipeline. As a result, existing systems suffer from several technical limitations: they cannot adapt recommendation timing and content to real-time user context, they cannot efficiently generate personalized proposals without extensive manual rule engineering, and they often impose redundant or conflicting notifications that degrade usability and system efficiency.

In particular, known systems that invoke a generative AI model generally construct prompt sentences in a fixed or naive manner, for example by embedding only raw schedule text, without considering sensor-derived emotional signals, biological parameters, historical feedback, or machine operation data. This leads to suboptimal utilization of the generative AI model and increased post-processing load on the server, because the model output frequently contains non-actionable or misaligned proposals that must be discarded or manually filtered. The absence of a feedback-driven update mechanism for prompt generation further prevents the system from improving recommendations over time based on actual execution results and user evaluations.

Moreover, conventional architectures handle user-facing scheduling and back-end optimization as largely independent subsystems. User terminals merely display static recommendations and collect limited acknowledgements, while the server performs isolated batch computations on schedule data. This separation prevents the server from performing fine-grained, time-aligned adjustments of proposal items in response to real-time execution status and emotion changes. Consequently, the overall computer system suffers from inefficient use of computational resources, duplicated scheduling logic, and an increased number of data synchronization steps.

In industrial environments, existing systems that monitor work machines or robots likewise rely on static thresholds or hand-crafted rules to determine maintenance or “stretch” operations. These systems generally do not exploit generative AI models to synthesize adaptive motion patterns from detailed operation histories, nor do they merge human activity data and machine operation data into a unified prompt for joint optimization. This results in conservative maintenance schedules, reduced machine utilization, and an inability to co-optimize human physical exercise and machine operation efficiency in a coordinated manner.

Accordingly, there is a need for an improved computer system and server-side processing architecture that: (i) acquires and integrates user activity information, emotion state information, biological state information, and work-machine operation information; (ii) automatically generates context-rich prompt sentences for a generative AI model; (iii) parses and time-aligns the model's responses into executable proposal items; and (iv) closes the loop by using user feedback and execution status to update both prompt generation logic and proposal generation conditions. By addressing these issues, the invention aims to improve the functioning of the computer system itself, including more efficient use of the generative AI model, reduction of redundant notifications, and more reliable and adaptive scheduling behavior.

The specific processing by the specific processing unit 290 of the data processing device 12 in Application Example 2 is realized by the following means.

The present invention provides a server comprising a processor configured to acquire activity information of a user from an input interface or from an external schedule management apparatus; organize, in system memory, a work status for each time segment based on the acquired activity information and schedule information obtained from an external information source; acquire, from at least one sensing apparatus, emotion state information and biological state information associated with the activity information; generate, by executing program instructions, a prompt sentence for a generative AI model based on the activity information, the emotion state information, and the biological state information so as to cause the generative AI model to generate proposals for efficient work management and physical exercise; transmit the generated prompt sentence to the generative AI model via a communication interface and receive, from the generative AI model, a response including the proposals; extract, by parsing the received response, proposal items including an execution time, execution content, and execution condition and adjust the proposal items in time so as to be consistent with a scheduled activity of the user; generate schedule management data and notification data based on the adjusted proposal items and transmit the notification data to a terminal device; and acquire, via the terminal device, execution status of the proposal items and evaluation information from the user, and update a content of the prompt sentence and generation conditions of the proposal items based on the evaluation information. This enables the computer-implemented system to dynamically adapt recommendation content and timing to real-time user context, to utilize the generative AI model more efficiently through feedback-optimized prompt sentences, to reduce redundant or conflicting notifications by server-side time alignment of proposal items, and to improve overall system performance in both personal work management and coordinated control of human physical exercise and work-machine operation.

The term “activity information” refers to information indicating actions, tasks, or scheduled events of a user over time, including at least start times, end times, and types or categories of activities such as work periods, breaks, and meetings.

The term “external schedule management apparatus” refers to an information processing apparatus or service that manages calendar data or schedule data for a user, and that is capable of providing such data to the server via a communication interface.

The term “time segment” refers to a discrete time interval, such as a minute, a plurality of minutes, or an hour, used by the processor to divide a day or a period into units for organizing work status or proposal items.

The term “work status” refers to a state of user activity in a given time segment, including at least an indicator of whether the user is working, resting, or performing another activity, and optionally posture, workload level, or context information.

The term “external information source” refers to any computing resource, network service, or storage apparatus that provides schedule information, health information, or operation information to the server through a communication network.

The term “emotion state information” refers to information representing an estimated emotional or psychological condition of a user, such as stress, relaxation, happiness, sadness, or neutrality, derived from sensor data or user input.

The term “biological state information” refers to information representing a physiological condition of a user, including at least one of heart rate, respiration rate, body movement level, sleep amount, or other biometric parameters.

The term “sensing apparatus” refers to any hardware component configured to capture data related to a user's physical or emotional state, including at least one of an image acquisition apparatus, a sound acquisition apparatus, a motion sensor, or a biometric sensor.

The term “image acquisition apparatus” refers to a device capable of capturing still images or moving images of a user, such as a camera integrated in a terminal device or an external imaging device.

The term “sound acquisition apparatus” refers to a device capable of capturing audio signals, such as a microphone integrated in a terminal device or an external audio input device.

The term “generative AI model” refers to a trained artificial intelligence model, such as a machine learning model implementing natural language processing, that generates text or other outputs in response to an input prompt sentence.

The term “prompt sentence” refers to a natural-language or structured textual input provided to the generative AI model, which describes context, constraints, and a requested output format so as to cause the generative AI model to generate desired proposals.

The term “proposal” refers to an item or a set of items generated by the generative AI model, indicating recommended actions, including at least one of work management instructions, physical exercise instructions, or work-machine operation patterns.

The term “proposal item” refers to a discrete element extracted from the response of the generative AI model, the element including at least an execution time, an execution content, and optionally an execution condition.

The term “execution time” refers to a point in time or a time interval at which a proposal item is recommended to be performed.

The term “execution content” refers to a description of an action or operation to be performed in accordance with a proposal item, such as a specified physical exercise or task.

The term “execution condition” refers to a condition or constraint associated with a proposal item, including at least timing constraints, prerequisite states, intensity levels, or environmental requirements.

The term “scheduled activity” refers to an activity of a user that is already included in schedule information or activity information and that defines occupied time slots within which proposal items may be adjusted or inserted.

The term “schedule management data” refers to data structures representing an arranged schedule for a user, including original scheduled activities and time-adjusted proposal items.

The term “notification data” refers to data specifying content, timing, and target of notifications to be output by a terminal device to inform the user of proposal items or schedule changes.

The term “terminal device” refers to an information processing device operated by a user, such as a mobile device, a tablet, a personal computer, or an industrial display device, that is capable of receiving notification data and presenting information to the user.

The term “execution status” refers to information indicating whether a user has performed, skipped, or partially performed a proposal item, including at least completion flags and timestamps.

The term “evaluation information” refers to information indicating a user's assessment of a proposal item, including at least satisfaction levels, difficulty levels, free-text comments, or other feedback values.

The term “generation conditions of the proposal items” refers to parameters, constraints, or rules used by the processor when generating the prompt sentence or post-processing the model response, such as preferred exercise types, notification frequency, or allowed time windows.

The term “emotion state” refers to a classified result representing the emotional condition of the user, obtained by analyzing emotion state information and expressed as one of a plurality of predefined emotion categories.

The term “work machine” refers to a mechanical apparatus or automated equipment, including industrial machinery or robots, which performs operations in a work environment and whose operation state can be monitored.

The term “operation state of the work machine” refers to information representing a working condition of a work machine, including at least operating time, cycle count, motion pattern, load condition, or error events.

The term “operation information of the work machine” refers to data describing the operation state of the work machine over time, which is supplied to the processor for analysis and prompt generation.

The term “motion pattern” refers to a sequence of movements or control commands for a work machine, designed to maintain or improve operation efficiency or to reduce mechanical fatigue.

The term “operation efficiency of a work machine” refers to a performance indicator of a work machine, including at least productivity, cycle time, downtime, or energy consumption, which is influenced by operation patterns and maintenance actions.

The term “communication interface” refers to hardware and software components that enable data exchange between the processor and external entities, including networks, generative AI models, terminal devices, and external information sources.

The term “system memory” refers to any volatile or non-volatile storage medium accessible by the processor, used to temporarily or permanently store activity information, sensor data, intermediate data structures, and generated proposal items.

In one embodiment, server, terminal, and user cooperate to implement the claimed system. Server includes at least one processor, system memory, a non-volatile storage device, and a communication interface connected to a network. Terminal includes at least one processor, memory, a display, an input interface such as a touch panel or keyboard, an image acquisition apparatus such as a camera, and a sound acquisition apparatus such as a microphone. User interacts with terminal to provide activity information and feedback and to receive notifications.

Server executes software modules implemented, for example, in a high-level programming language running on an operating system. Server executes a schedule acquisition module, a context aggregation module, an emotion and biological state estimation module, a prompt generation module, a generative AI interface module, a response parsing module, a time-alignment module, a schedule and notification generation module, and a feedback learning module. Server stores activity information, sensor data, intermediate features, and proposal items in a database system, for example a relational database.

Terminal executes an application that provides user interfaces and local processing. Terminal displays calendar views and forms that allow user to input activity information such as start time, end time, and activity type. Terminal acquires facial images through the camera and voice signals through the microphone, and stores them temporarily in local memory.

Terminal can execute image preprocessing using a computer vision library and audio preprocessing using an audio analysis library before sending feature data to server.

Server uses a specific data structure to represent activity information. Server represents a daily schedule as an ordered list of records, each record including fields such as user identifier, start time, end time, activity category, and posture type. Server stores this list in memory as a time-sorted array or a table indexed by time. Server merges this schedule data with external schedule data obtained from an external schedule management apparatus via an application programming interface. By normalizing all schedules into a unified structure, server reduces the number of database joins and simplifies time-segment computations, which improves processing speed and reduces memory overhead compared with ad hoc text-based schedule handling.

Server acquires emotion state information and biological state information from multiple sources. Terminal transmits preprocessed facial images and voice features to server over a secure channel. In one embodiment, terminal downsamples facial images, converts them to grayscale, and crops them to a standard resolution using a computer vision library. Terminal computes low-dimensional audio features such as Mel-frequency cepstral coefficients and pitch statistics using an audio analysis library. These feature vectors reduce network bandwidth usage and allow server to process a fixed-size representation per time segment. This architecture reduces communication load and latency compared with sending raw media streams.

Server estimates emotion state by executing a trained neural network model. In one embodiment, server uses a convolutional neural network for images, having multiple convolutional layers with rectified linear unit activations and pooling layers, followed by fully connected layers that output class probabilities for emotion categories. Server applies softmax activation in the output layer and uses a cross-entropy loss function during training.

Server trains this model using a dataset of face images labeled with emotion categories, applies data augmentation such as random cropping, rotation, and brightness adjustment, and updates weights using a stochastic gradient descent optimizer or an adaptive optimizer. This training procedure reduces overfitting and improves classification accuracy under variable lighting and pose conditions.

Server also uses a recurrent or transformer-based neural network to process audio features, mapping sequences of feature vectors to emotion probabilities. Server concatenates or otherwise fuses image-based emotion probabilities and audio-based emotion probabilities, for example by weighted averaging or by inputting them into a small fusion network. Server outputs a final emotion state label and a confidence score for each time segment, and writes this to the database along with timestamps that correspond to activity segments.

Server optionally processes biological state information such as heart rate, steps, and sleep amount obtained from external health tracking apparatuses. Server aggregates this numerical data per time segment using an analytical library, computing features such as average heart rate, heart rate variability, step frequency, and deviations from the user's baseline. Server then attaches these biological features to the time-segment structure used for prompt generation. This unified representation aligns activity, emotion, and biological states, and reduces the complexity of subsequent computations.

Server generates a prompt sentence for a generative AI model by executing a deterministic algorithm that constructs a textual description from the structured context. Server takes as input the time-segment array and the emotion and biological features, selects salient segments according to heuristics or learned weights, and formats them into natural language. For example, server can generate a prompt sentence such as:

“Based on the following schedule and emotional and biological states, propose optimal work management actions and physical exercises. Schedule: 9:00-12:00 standing assembly work, high workload; 12:00-13:00 lunch; 13:00-17:00 desk work, moderate workload. Emotion state: mostly stressed from 10:00 to 11:30, neutral in the afternoon. Biological state: reduced sleep (5 hours last night), elevated heart rate during the morning. Output a list of concrete recommendations, each with a start time, duration in minutes, and a short description of the action or exercise.”

Server uses a prompt template and inserts structured fields into predefined clauses. This approach constrains the input to the generative AI model, reduces ambiguity, and biases the model toward producing consistent and parseable outputs. By systematically encoding multi-modal context into the prompt sentence, server improves the effective accuracy of the generative AI model's output and reduces the need for heavy post-processing.

Server communicates with the generative AI model through a generative AI interface module. In one embodiment, server transmits the prompt sentence to a remote generative AI model via an application programming interface, specifying model identifier, output length constraints, and sampling parameters such as temperature and top-k. In another embodiment, server executes a local generative language model stored in server memory. In both cases, server treats the generative AI model as a black-box text-to-text transformation, but constrains its behavior via prompt design and response post-processing.

Server parses the text response from the generative AI model using a response parsing module. To avoid ambiguity, server instructs the model in the prompt to output recommendations in a line-or bullet-based format. Server applies a tokenizer to split the response into lines and then applies regular expressions or a finite-state parser to extract time expressions, duration values, and action descriptions. For example, if the response contains:
“1) At 10:30:5 minutes of seated neck and shoulder stretching.
2) At 11:30:3 minutes of deep breathing and hand rotation.
3) At 15:00:5 minutes of standing back stretch.” server identifies times “10:30”, “11:30”, and “15:00”, durations “5 minutes”, “3 minutes”, and “5 minutes”, and textual descriptions “seated neck and shoulder stretching”, “deep breathing and hand rotation”, and “standing back stretch”. Server converts these into structured proposal items and stores them in the database as records with normalized time fields and references to the corresponding activity segments.

Server then adjusts the proposal items to be consistent with the user's scheduled activities. Server compares the suggested execution times with the schedule array and evaluates conflicts, for example when a proposed exercise falls inside a meeting. Server shifts the execution time according to conflict-resolution rules, such as moving the recommendation to the nearest available interval within a maximum offset limit. By executing this alignment algorithm on structured data, server automatically avoids overlapping notifications and reduces the need for user manual adjustment, which improves the practical usability of the system and reduces cognitive load.

Server generates schedule management data and notification data based on the adjusted proposal items. Server constructs calendar events or reminder objects that can be inserted into an external schedule management apparatus via a calendar interface. Server also builds compact notification payloads containing only essential fields required for terminal display, which reduces communication bandwidth. For each proposal item, server prepares a notification text such as “At 10:35:5-minute seated neck and shoulder stretch” and includes identifiers linking the notification to the originating proposal item for later feedback tracking.

Terminal receives notification data from server and registers local notifications using its operating system. Terminal displays notifications at the specified times and opens a detailed instruction screen when the user interacts. On this screen, terminal presents the execution content, duration, and any execution conditions. Terminal may also show simple icons or animations that visually demonstrate the recommended physical exercise. User can start or skip the exercise and may indicate completion or difficulty level using on-screen controls.

User provides feedback via terminal for each proposal item. Terminal records information such as completion flag, perceived difficulty, pain presence, and free-text comments. Terminal batches this feedback and transmits it to server. This feedback constitutes evaluation information that server uses to refine subsequent prompt sentences and generation conditions.

Server executes a feedback learning module that updates profile data and prompt generation logic. Server aggregates feedback statistics by exercise type, time of day, emotion state, and biological state. For example, server may observe that certain stretching exercises have low completion rates in early morning segments or that intense lower-body exercises frequently receive “too hard” evaluations when emotion state is stressed. Server encodes these observations into preference parameters such as penalty weights for certain action categories under specific conditions.

Server modifies prompt generation by embedding these learned constraints directly into future prompt sentences. For example, server can generate a new prompt sentence: “Based on the following schedule, emotional and biological states, and the fact that the user prefers short, low-impact stretches for the lower back in the afternoon, propose two exercises that each last no more than 3 minutes and do not require standing up.”

By explicitly encoding preferences into the prompt text, server guides the generative AI model to avoid actions that the user is unlikely to perform and to favor actions with historically high completion. This reduces wasted notifications and improves the effectiveness of the generated proposals. Because the prompt modification is performed autonomously by server based on structured feedback, the system achieves an adaptive behavior that would not result from a static rule-based design.

In another embodiment, server integrates work machine operation information into the context for the generative AI model. Server acquires operation logs from work machines, including metrics such as cycle count, continuous operation duration, axis position histograms, temperature readings, and error events. Server aggregates these metrics per time segment and derives indicators of mechanical fatigue risk or efficiency degradation. Server then generates a prompt sentence combining human activity information and work machine operation information, for example: “The user performs standing assembly work from 9:00 to 12:00 next to Work Machine A. Work Machine A has executed 5000 repetitive pick-and-place cycles over the last 5 hours without a pause. Propose a motion pattern for Work Machine A that can be executed within 2 minutes to reduce mechanical fatigue, and propose a synchronized 2-minute stretch for the user during that maintenance period.”

Server sends this prompt sentence to the generative AI model and receives a dual recommendation: a human exercise and a machine motion pattern. Server parses the machine-related recommendation into a sequence of positions or motion states that can be translated into low-level control commands for the work machine. By generating correlated human and machine actions, the system co-optimizes human physical condition and machine operation efficiency.

Server achieves technical improvements beyond simple automation by its design choices.

First, by using structured time-segment arrays and feature vectors, server reduces the complexity of state retrieval and compression, leading to faster context construction for the generative AI model. Second, by using a neural network-based emotion estimation with trained weights and feature-level fusion, server achieves higher accuracy and robustness in emotion detection compared with simple threshold or rules-based methods, which directly improves the relevance of generated prompts and proposals. Third, by constraining generative outputs through prompt engineering and deterministic post-parsing, server reduces parsing errors and achieves predictable data structures from free-form text. This significantly lowers computation required for error handling and re-generation.

Furthermore, server reduces communication load by having terminal perform local preprocessing of media data into compact feature representations, and by transmitting only essential notification data to terminal rather than entire schedules. This division of labor and selection of data structures yields lower bandwidth consumption and shorter end-to-end latency. These are technical effects on the operation of the computing system itself.

Server employs training methods for the emotion and context models that further contribute to system performance. During model training, server applies mini-batch optimization, adaptive learning rate schedules, and regularization techniques to obtain models that converge faster and generalize better. In some embodiments, server performs incremental learning using newly collected data from deployed systems, carefully controlling for drift by monitoring validation performance. This continual adaptation improves classification accuracy over time, which enhances the quality of prompt construction and downstream generative outcomes.

The described system is not limited to the specific neural network architectures mentioned. In alternative embodiments, server uses different model structures such as residual networks, graph-based models for activity relationships, or encoder-decoder architectures for richer context encoding. Server may also employ different optimization algorithms or loss functions based on the target task. However, in each case, server uses explicit, pre-defined pipelines and data structures to transform raw sensor and schedule data into compact features, constructs prompt sentences that integrate these features in a controlled way, and performs deterministic parsing of model outputs into executable proposal items.

User can deploy the system in various environments. In an office environment, user uses terminal as a personal computing device. In a factory environment, terminal may be a large display panel or industrial tablet placed near work stations, and work machine controllers provide operation logs via industrial communication buses. In a remote work scenario, terminal may be a portable device, and server resides in a remote data center.

The embodiments described above can be modified without departing from the scope of the claims. For example, server can omit emotion estimation and use only biological state signals when visual or audio input is not available. Server can also adjust the granularity of time segments depending on system capabilities, using longer segments to reduce computational load or shorter segments to enhance responsiveness. Terminal may perform more or less preprocessing of sensor data depending on its processing capability.

In all these embodiments, server, terminal, and user cooperate in a specific, technically-defined way: server constructs a unified context from multiple heterogeneous data sources, transforms it into a prompt sentence for a generative AI model, interprets and aligns the generated proposals using deterministic algorithms, and closes the loop with feedback-driven updates. This configuration improves the functioning of the computer system itself by enhancing the efficiency and accuracy of context-aware recommendation generation, reducing communication overhead, and enabling coordinated control of human behavior guidance and machine operation.

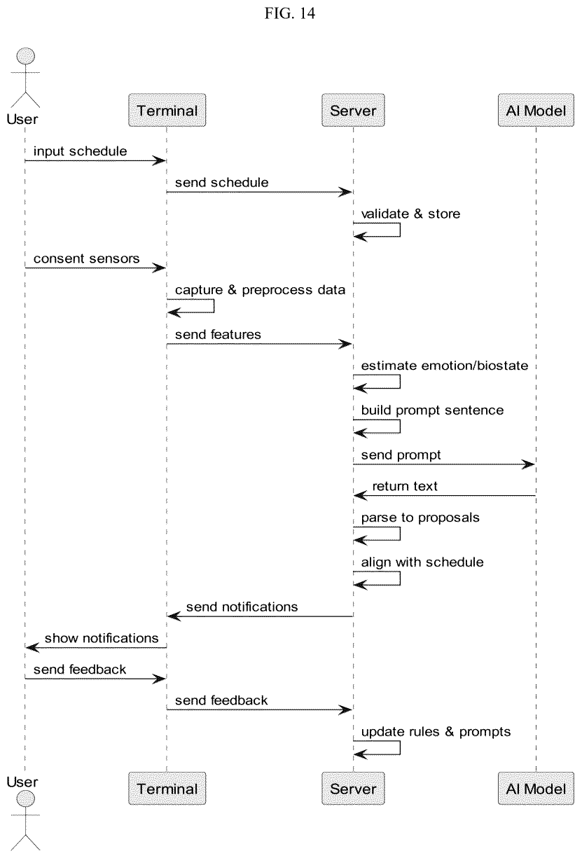

The following describes the processing flow using FIG. 14.

### Step 1

User operates the terminal to input activity information for at least one day.

User enters, as input, start times, end times, activity types, and optional notes through a calendar or form interface displayed on the terminal.

Terminal receives this input, converts it into a structured internal representation (for example, a list of records with fields such as user ID, start time, end time, activity category, and posture type), and outputs the structured activity information as a JSON or similar data object.

### Step 2

Terminal transmits the structured activity information to the server.

Terminal takes, as input, the internal data structure created in Step 1, serializes it into a network-transfer format such as JSON, and sends it via a secure communication protocol to a predefined application programming interface of the server.

Terminal outputs a network request containing the activity information and a user identifier, which becomes the input to the server in the next step.

### Step 3

Server receives and validates the activity information.

Server takes, as input, the serialized activity information from the terminal, parses the data into an in-memory structure, and performs data checks such as verifying time formats, confirming that end times are later than start times, and detecting overlapping or inconsistent entries.

Server outputs a cleaned and normalized schedule structure, for example an ordered array of time-sorted segments, and stores this schedule in a database associated with the user ID.

### Step 4

Server augments the schedule with external schedule management data.

Server uses, as input, the cleaned schedule structure and, when permitted, access tokens for an external schedule management apparatus. Server calls an external service to retrieve additional calendar entries, converts these entries into the same internal structure, and merges them with the existing schedule by performing time-based insertion and conflict resolution.

Server outputs a unified schedule representation that contains both user-entered and externally obtained activities, aligned on a common time axis.

### Step 5

Terminal captures emotion-related and biological-related raw data.

Terminal uses, as input, configuration indicating that emotion and biological state monitoring are enabled and user consent information. Terminal activates the camera and microphone to acquire facial images and voice signals during specified periods and may also read local sensor data such as accelerometer values.

Terminal outputs raw media samples and sensor readings tagged with timestamps into local buffers for preprocessing.

### Step 6

Terminal preprocesses emotion-related data and transmits compact features to the server.

Terminal takes, as input, the raw images and audio from Step 5, applies image preprocessing (for example, face detection, cropping, resizing, grayscale conversion) and audio preprocessing (for example, computing Mel-frequency cepstral coefficients and basic statistics) to reduce dimensionality. Terminal then packages the resulting feature vectors with timestamps.

Terminal outputs compact emotion-related feature data and sends this data over the network as the input for the server's emotion estimation.

### Step 7

Server estimates the emotion state per time segment.

Server takes, as input, the feature vectors from the terminal and the unified schedule from Step 4. Server executes a trained neural network model, such as a convolutional network for visual features and a sequence model for audio features, to compute probabilities for predefined emotion categories for each feature sample. Server aligns these probabilities with the time segments of the schedule by matching timestamps and aggregating multiple samples within each segment (for example, by averaging probability distributions).

Server outputs an emotion state label and confidence value for each time segment, and stores these as additional fields in the segment records.

### Step 8

Server integrates biological state information into the time-segment structure.

Server uses, as input, biological state data (for example, heart rate, step count, sleep amount) received from external health tracking apparatuses or from the terminal. Server aggregates these raw measurements by time segment, computing features such as mean, variance, and deviations from a baseline.

Server outputs enhanced time-segment records that now contain activity information, emotion state information, and biological state information for each segment.

### Step 9

Server constructs a context representation for prompt generation.

Server takes, as input, the enhanced time-segment records from Step 8 and a description of the desired type of proposals (for example, physical exercise, work management, or combined human-machine optimization). Server selects relevant segments (for example, long continuous work periods with high stress or low movement) and summarizes each into descriptive phrases by combining activity category, emotion state, and biological indicators.

Server outputs an ordered list of segment summaries and high-level constraints that will be embedded into a prompt sentence.

### Step 10

Server generates a prompt sentence for the generative AI model.

Server uses, as input, the segment summaries and constraints from Step 9 and a stored prompt template corresponding to the selected use case. Server concatenates template phrases and segment descriptions into a natural-language prompt sentence that specifies required output format and constraints. For example, server can generate: “Based on the following schedule and emotional and biological states, propose optimal work management actions and physical exercises. Schedule: 9:00-12:00 standing assembly work, high workload; 12:00-13:00 lunch; 13:00-17:00 desk work, moderate workload. Emotion state: mostly stressed from 10:00 to 11:30, neutral in the afternoon. Biological state: reduced sleep (5 hours last night), elevated heart rate during the morning. Output a list of concrete recommendations, each with a start time, duration in minutes, and a short description of the action or exercise.”

Server outputs the completed prompt sentence as a text string ready to be sent to the generative AI model.

### Step 11

Server transmits the prompt sentence to the generative AI model and obtains a textual response.

Server takes, as input, the prompt sentence from Step 10 and configuration parameters for the generative AI model, such as model name and generation settings. Server calls the generative AI model via a communication interface, includes the prompt sentence in the request, and waits for the model to return generated text.

Server outputs the generative AI model's response text, which includes proposed execution times, durations, and action descriptions, and stores this text for parsing.

### Step 12

Server parses the model response into structured proposal items.

Server uses, as input, the response text from Step 11. Server tokenizes the text into lines or logical segments, applies pattern matching and numeric extraction to identify time expressions, duration values, and action descriptions, and then constructs a structured proposal record for each identified recommendation.

Server outputs a list of proposal items, each containing at least an execution time, execution duration, and execution content, represented in normalized time format and stored in memory or the database.

### Step 13

Server aligns proposal items with the existing schedule and resolves conflicts.

Server takes, as input, the list of proposal items from Step 12 and the unified schedule with time segments. Server compares recommended times with the user's scheduled activities, detects conflicts like overlap with fixed meetings, and adjusts times according to pre-defined rules (for example, moving the proposal to the nearest free time segment within defined limits). This adjustment involves calculating free intervals and selecting the best fit based on duration and priority.

Server outputs an adjusted list of proposal items whose execution times are consistent with the user's schedule and constraints.

### Step 14

Server generates schedule management data and notification data.

Server uses, as input, the adjusted proposal items from Step 13. Server creates calendar entries or schedule objects that include start time, end time, title, and description, and it generates notification payloads containing concise messages, identifiers, and trigger times. Server may also assign priority levels or categories to each notification.

Server outputs a structured set of schedule management data for possible synchronization with external calendars and a set of notification data for transmission to the terminal.

### Step 15

Server transmits notification data to the terminal.

Server takes, as input, the notification data from Step 14 and the user's device information.

Server formats the notification data into a compact message, bundles multiple notifications if needed to reduce overhead, and sends them over the network to the terminal using a push mechanism or pull API.

Server outputs the serialized notification payload, which becomes the input for notification registration on the terminal.

### Step 16

Terminal registers and displays notifications to the user.

Terminal uses, as input, the notification payload from the server. Terminal stores the notification items in local storage, converts the trigger times into the terminal's local time zone, and registers them with the operating system's notification scheduler. When trigger times are reached, terminal displays notifications on the screen, possibly with sound or vibration alerts, and allows user to tap to open a detailed view.

Terminal outputs visual and audio notification outputs that present execution times and exercise or work-management instructions to user.

### Step 17

User executes or skips recommended proposal items and provides feedback.

User receives, as input, the notifications and detailed instructions presented by the terminal.

User may perform the recommended physical exercise or work-management action, or may choose to skip it. Afterward, user interacts with terminal to indicate completion, difficulty, or satisfaction, optionally entering free-text comments.

User outputs feedback input signals through terminal controls, which terminal records as execution status and evaluation information.

### Step 18

Terminal transmits execution status and evaluation information to the server.

Terminal takes, as input, the recorded feedback associated with each proposal item, including completion flags, timestamps, difficulty ratings, and comments. Terminal groups these records into a feedback payload and sends them to the server via a secure communication protocol.

Terminal outputs the serialized feedback data, which serves as the input for the server's feedback learning process.

### Step 19

Server updates prompt generation content and proposal generation conditions based on feedback.

Server uses, as input, the feedback data from Step 18 and the stored history of proposal items and context. Server computes statistics such as completion rates by exercise type, time of day, emotion state, and biological state, and then adjusts internal preference parameters (for example, reducing selection probability for exercises frequently marked “too hard”). Server then modifies templates and constraints used in prompt generation, for example by inserting clauses like “avoid high-impact lower-body exercises in the morning” into future prompt sentences.

Server outputs updated configuration for the prompt generation module and updated generation conditions, which will influence subsequent prompt sentences and the structure of new proposal items.

### Step 20

Server optionally integrates work machine operation information into future prompts and proposals.

Server takes, as input, operation logs from work machines, including cycle counts, operation times, and error events, together with the user's schedule and feedback-refined preferences. Server aggregates machine state by time segment, identifies segments with high mechanical strain, and creates additional context fields describing machine state. Server then incorporates this context into prompt sentences for the generative AI model, such as adding: “Work Machine A has executed 5000 repetitive cycles over the last 5 hours without a pause. Propose a motion pattern for Work Machine A and a synchronized exercise for the user.”

Server outputs enriched prompt sentences and corresponding structured proposals that jointly address human exercise and machine motion, which then proceed through the same parsing, alignment, notification, and feedback steps as human-focused proposals.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

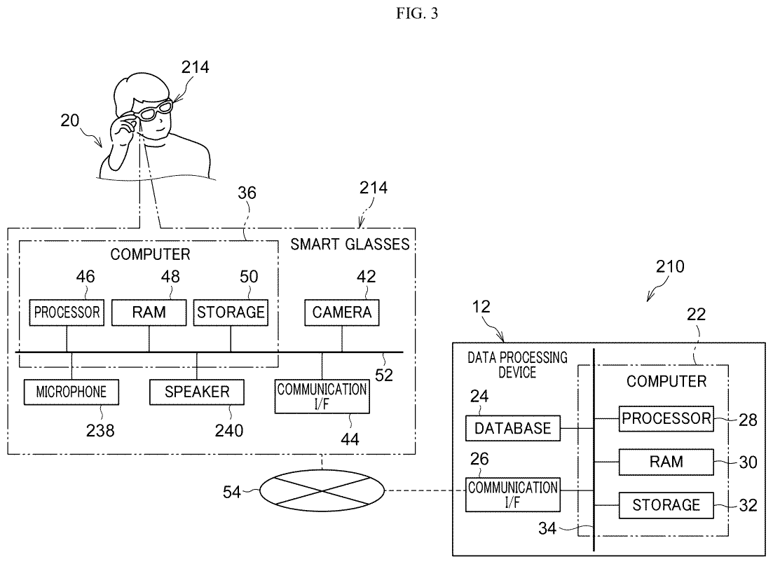

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

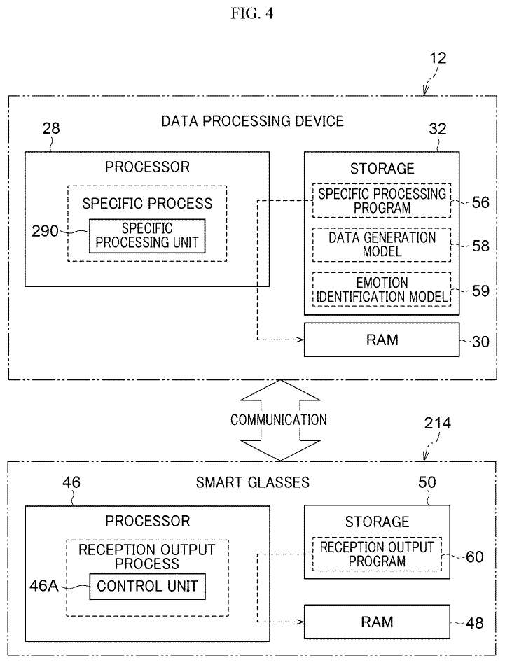

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

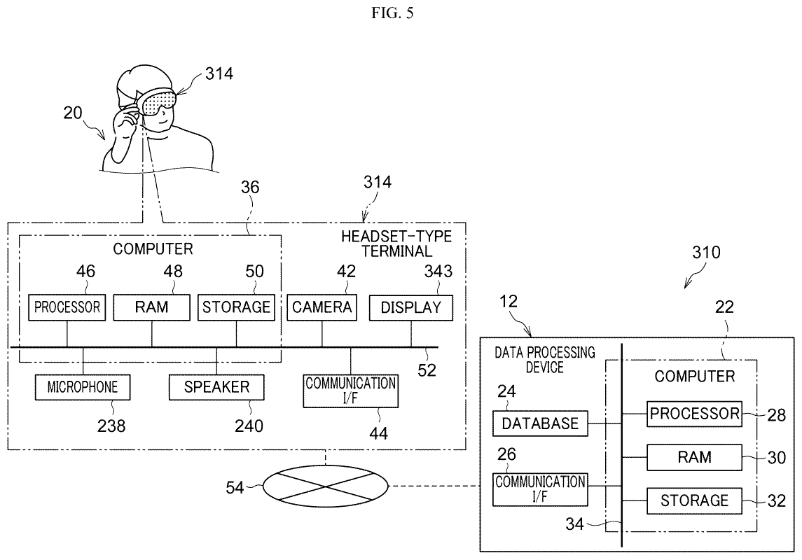

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

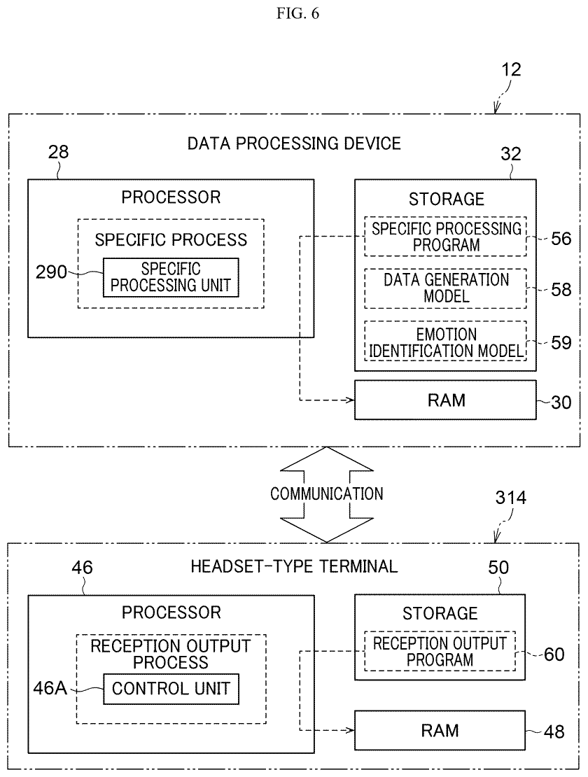

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

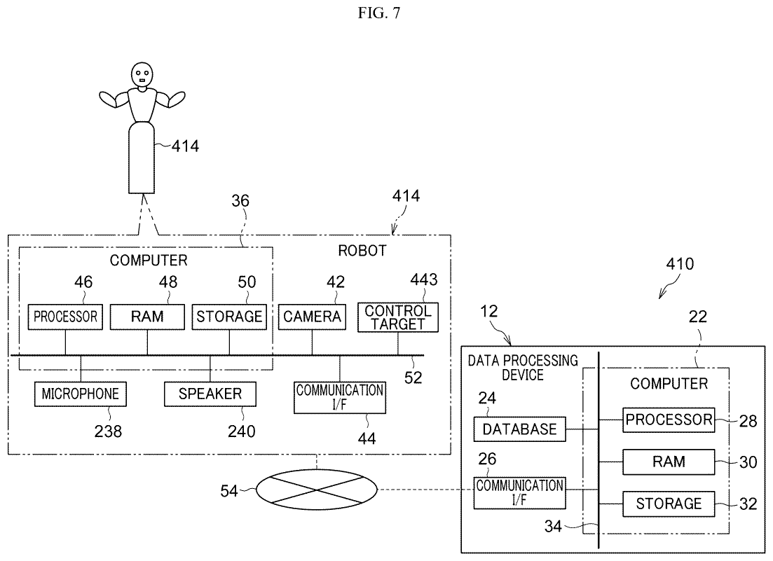

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

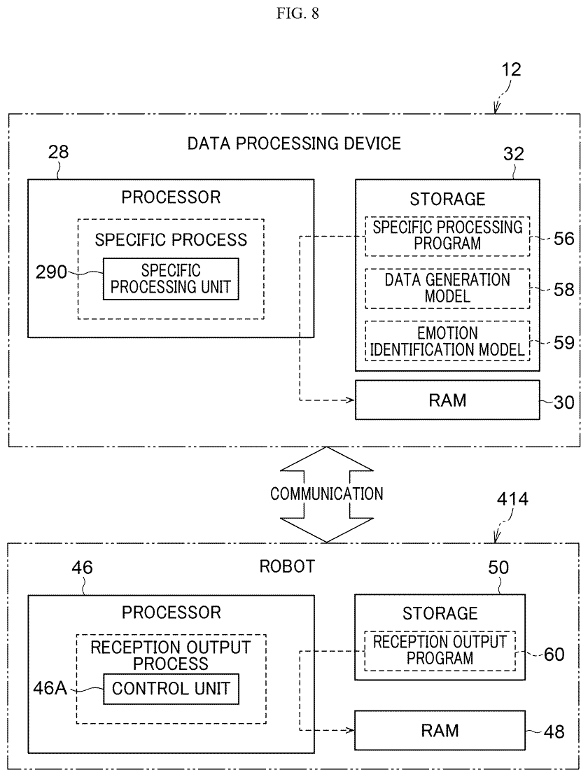

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

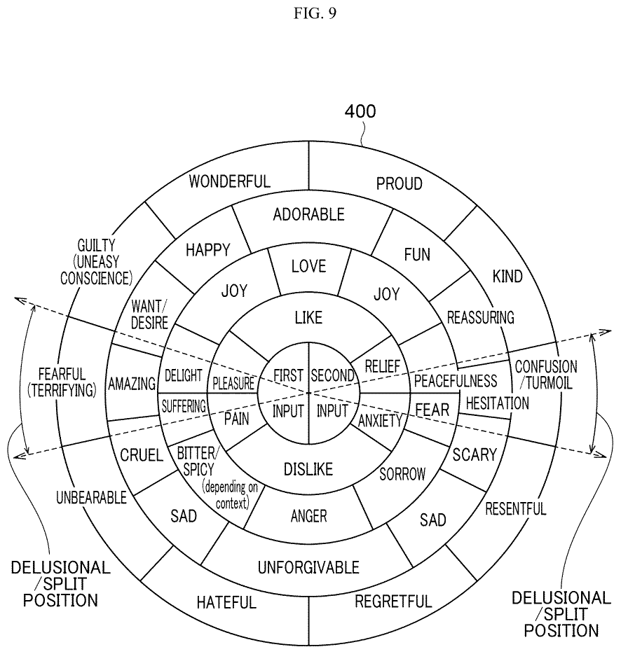

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

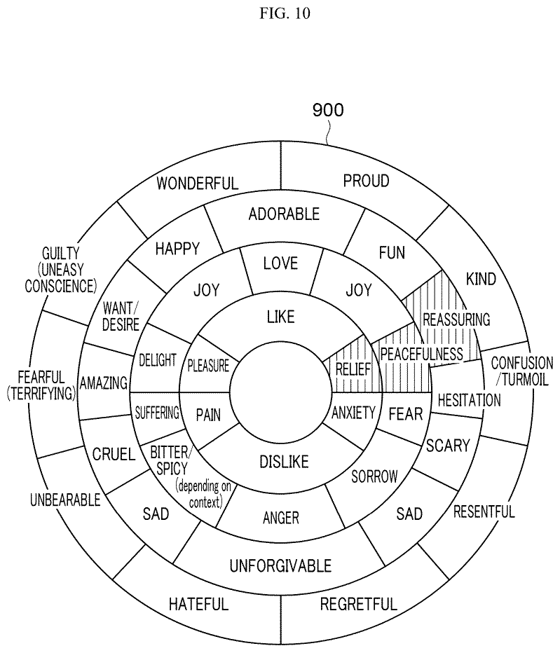

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive, via a communication network, schedule data transmitted from a user terminal, the schedule data including time information and content information relating to daily activities of a user,
execute data validation processing on the received schedule data by verifying consistency including a time format and presence of required items, and store validated schedule data as structured information in the storage device in association with identification information,
generate description information representing activity time periods and activity types of the user based on the stored schedule data, and generate a prompt by creating a prompt sentence including the description information and instruction information requesting proposals for efficient work management based on the user schedule,
transmit the generated prompt, in accordance with a communication protocol, to a generative artificial intelligence model implemented by an external inference apparatus or an internal inference apparatus, and request a proposal generation process based on natural language processing by the generative artificial intelligence model,
receive, from the generative artificial intelligence model, response data including work management proposals generated in response to the prompt and associated with the schedule data of the user, and convert the response data into display information suitable for presentation by a user interface, and
transmit the display information to the user terminal so that the display information is output in a visually perceptible format on the user terminal.

### Supplementary 2

The system according to supplementary 1,
wherein the processor is configured to
reconstruct, from the response data received from the generative artificial intelligence model, the work management proposals as time-period-specific proposal information by associating the work management proposals with respective time segments of the schedule data of the user, and generate display control information that uses the time-period-specific proposal information to superimpose proposal content on a time-axis display or list display representing the schedule data of the user.

### Supplementary 3

The system according to supplementary 1,

wherein the processor is configured to
generate updated schedule data by adding new activity information or activity-segment information to the stored schedule data, or by modifying time periods or content of existing activity information, based on the work management proposals received from the generative artificial intelligence model, re-store the updated schedule data in the storage device in association with identification information of the user, and generate notification information based on the updated schedule data and transmit the notification information to the user terminal.

### Application Example 1

### Supplementary 1

A system comprising a processor,
wherein the processor is configured to
receive behavior schedule information of a user as input,
convert and format the behavior schedule information into structured data,
generate, based on the structured data, a prompt sentence that describes in natural language a daily activity plan including the behavior schedule information,
convert the prompt sentence and the structured data into input data in a format suitable for generation of an operation plan, and input the input data into a generative artificial intelligence model,
analyze response data output from the generative artificial intelligence model and extract, as operation schedule information, at least an operation start time, an operation end time, a boarding point, and an alighting point for an automated mobile body,
determine temporal consistency of the operation schedule information and consistency between the operation schedule information and the behavior schedule information, and perform correction or adjustment based on a predetermined rule, and
convert corrected or adjusted operation schedule information into notification data and transmit the notification data to a display device via a communication network.

### Supplementary 2

The system according to supplementary 1,
wherein the processor is configured to generate, as the structured data, table-type data including time information and position information, and commonly use the table-type data as input to the generative artificial intelligence model and in generation processing of the operation schedule information.

### Supplementary 3

The system according to supplementary 1,

wherein the processor is configured to generate, as the notification data, time information for notifying the display device a predetermined time before a scheduled departure time corresponding to each movement section of the operation schedule information, and transmit the notification data to the display device.

### Example 2

### Supplementary 1

A system comprising a processor,
wherein the processor is configured to
acquire behavior schedule information of a user from a terminal device, receive, from the terminal device, the behavior schedule information and store the behavior schedule information as structured information including time information and behavior type information,
analyze the structured information to extract a continuous static-state interval in which the user is expected to remain in a substantially sedentary state for a predetermined period, and calculate a candidate exercise execution time zone corresponding to the continuous static-state interval,
generate a prompt sentence in a natural language based on the behavior schedule information and the candidate exercise execution time zone, the prompt sentence including constraint conditions comprising preference information of the user and exercise condition information,
input the prompt sentence to a generative AI model so as to instruct the generative AI model to generate a proposal of an exercise content and an exercise time zone corresponding to the candidate exercise execution time zone,
receive proposal information output from the generative AI model,
extract, from the proposal information, exercise time zone information and exercise content information as exercise proposal information,
adjust the exercise proposal information so as to be consistent with the behavior schedule information, and generate notification information including the exercise time zone information and the exercise content information,
transmit the notification information to the terminal device, and
control the terminal device so that the terminal device outputs, based on the notification information, a visual or auditory notification at a time corresponding to the exercise time zone information.

### Supplementary 2

The system according to supplementary 1,
wherein the processor is configured to
acquire, from the terminal device, execution status information or evaluation information of the user with respect to the proposal information output from the generative AI model,
store the execution status information or the evaluation information in association with the behavior schedule information and the exercise proposal information, and
include the stored execution status information or the stored evaluation information in the prompt sentence so as to adaptively update, for each user, the proposal of the exercise time zone and the exercise content generated by the generative AI model.

### Supplementary 3

The system according to supplementary 1,
wherein the processor is configured to
specify, in the prompt sentence, that the proposal information output from the generative AI model is to be output in a machine-readable data format having a predetermined format, analyze the machine-readable data format to extract the exercise time zone information and the exercise content information, and
cause the terminal device to automatically register, based on the machine-readable data format, a plurality of notification events corresponding to the exercise time zone information and the exercise content information.

### Application Example 2

### Supplementary 1

A system comprising a processor,
wherein the processor is configured to
acquire activity information of a user from an input interface or from an external schedule management apparatus,
organize a work status for each time segment based on the acquired activity information and schedule information obtained from an external information source,
acquire emotion state information and biological state information associated with the activity information from at least one sensing apparatus,
generate a prompt sentence for a generative AI model based on the activity information, the emotion state information, and the biological state information so as to cause the generative AI model to generate proposals for efficient work management and physical exercise,
transmit the generated prompt sentence to the generative AI model and receive, from the generative AI model, a response including the proposals,
extract proposal items including an execution time, execution content, and execution condition from the received response and adjust the proposal items in time so as to be consistent with a scheduled activity of the user,
generate schedule management data and notification data based on the adjusted proposal items and transmit the notification data to a terminal device, and
acquire, via the terminal device, execution status of the proposal items and evaluation information from the user, and update a content of the prompt sentence and generation conditions of the proposal items based on the evaluation information.

### Supplementary 2

The system according to supplementary 1,
wherein the processor is configured to
estimate the emotion state of the user by analyzing facial information and voice information acquired from an image acquisition apparatus and a sound acquisition apparatus as the emotion state information, and to reflect the estimated emotion state in the prompt sentence.

### Supplementary 3

The system according to supplementary 1,
wherein the processor is configured to
include, as the proposal items, a motion pattern for maintaining an operation efficiency of a work machine based on an operation state of the work machine in addition to physical exercise proposals for the user, and to transmit to the generative AI model the prompt sentence in which the activity information of the user and operation information of the work machine are described together.

What is claimed is:

1. A system comprising:
circuitry configured to:
receive, via a communication interface coupled to a packet-switched network, schedule data from a terminal device comprising time parameters and content parameters for a plurality of activity entries, execute format validation and completeness verification on the schedule data, and store validated schedule data as structured records with temporal indexes in a storage device in association with identification information;
query the storage device to retrieve activity entries within a specified time window, extract temporal attributes and content attributes from the retrieved structured records, tokenize a prompt sentence incorporating the extracted attributes and an instruction for a generative neural network model to generate structured proposals, and transmit the tokenized prompt sentence to an inference engine executing the generative neural network model; and
decode an output token sequence from the inference engine to obtain a proposal text string, parse the proposal text string to extract proposal records and map each proposal record to a corresponding time segment of the structured records, generate display control information that superimposes the mapped proposal records on a time-axis display representation of the schedule data, and transmit the display control information to the terminal device via the communication interface.

2. The system according to claim 1, wherein the circuitry is configured to execute the format validation by parsing each activity entry in the schedule data, applying a time format validation rule to the time parameter field, verifying that content parameter fields satisfy a minimum completeness criterion, and generating a validation error record for activity entries that fail any validation rule.

3. The system according to claim 2, wherein the circuitry is configured to store the validated schedule data as structured records by mapping time parameter fields to indexed temporal columns and content parameter fields to text columns in a relational data store, and creating temporal indexes on the time parameter columns to enable efficient range query retrieval.

4. The system according to claim 3, wherein the circuitry is configured to generate the prompt sentence by assembling segments comprising the structured text representation of activity patterns, statistical summaries of activity type frequencies and duration distributions, and an instruction specifying a target output format for the generated proposals.

5. The system according to claim 4, wherein the circuitry is configured to apply subword segmentation to the prompt sentence prior to tokenization, encode the segmented prompt sentence using a vocabulary index of the generative neural network model stored in the storage device, and configure inference parameters including temperature and maximum output length prior to transmission to the inference engine.

6. The system according to claim 1, wherein the circuitry is configured to parse the proposal text string by applying a temporal alignment procedure that identifies time references in the decoded output and maps each identified time reference to a corresponding activity entry identifier in the structured records of the storage device.

7. The system according to claim 6, wherein the circuitry is configured to generate the display control information by computing overlay geometry parameters for each mapped proposal record, including a time-axis position determined from the corresponding activity time segment and a display priority score, and encoding the overlay geometry parameters as rendering instructions.

8. The system according to claim 7, wherein the circuitry is configured to generate updated schedule data by merging accepted proposal records into the structured records of the storage device, updating the identification information to include a proposal incorporation timestamp, and generating updated display control information reflecting the merged proposals.

9. The system according to claim 1, wherein the circuitry is configured to retrieve prior proposal records from the storage device using the identification information, generate an updated prompt sentence incorporating the prior proposal records and current schedule data, tokenize the updated prompt sentence, and retransmit the tokenized updated prompt sentence to the inference engine to generate revised proposals.

10. The system according to claim 9, wherein the circuitry is configured to compute a schedule change score by applying a difference function to the current structured records and prior structured records in the storage device, and include the schedule change score in the updated prompt sentence to condition the inference engine on the magnitude of schedule changes.

11. The system according to claim 1, wherein the circuitry is configured to monitor execution status of activity entries by receiving status update messages from the terminal device via the communication interface, store the status update messages in the storage device in association with corresponding activity entry identifiers, compute an activity completion rate from the accumulated status update records, and include the computed activity completion rate in the prompt sentence to condition the inference engine on actual execution progress.

12. The system according to claim 11, wherein the circuitry is configured to generate a notification message for transmission to the terminal device when the activity completion rate falls below a threshold, and update the inference parameters based on the activity completion rate.

13. The system according to claim 1, wherein the circuitry is configured to receive, via the communication interface, external event data from an external information processing apparatus, apply a temporal overlap detection function to identify conflicts between the external event data and existing structured records in the storage device, and generate a conflict prompt sentence that includes conflict description information derived from overlapping activity entries.

14. The system according to claim 13, wherein the circuitry is configured to tokenize the conflict prompt sentence, transmit the tokenized conflict prompt sentence to the inference engine, decode an output token sequence to obtain a conflict resolution proposal, and transmit a resolution notification message including the conflict resolution proposal to the terminal device via the communication interface.

15. The system according to claim 1, wherein the circuitry is configured to store the tokenized prompt sentence, the proposal text string, and the mapped proposal records as a generation session record in the storage device, and retrieve prior generation session records to compute a proposal acceptance rate indicating the fraction of prior proposals incorporated into updated schedule data.

16. The system according to claim 15, wherein the circuitry is configured to use the proposal acceptance rate as a feedback signal to adjust a temperature parameter of the inference engine in subsequent prompt transmissions, applying a lower temperature parameter when the proposal acceptance rate is above a threshold to generate more focused proposals.

17. The system according to claim 1, wherein the circuitry is configured to generate, in addition to the time-axis display representation, a list display representation of the mapped proposal records sorted by display priority score, and transmit both display representations as alternative display control information items to the terminal device via the communication interface.

18. A system comprising:
circuitry configured to:
receive, via a communication interface coupled to a packet-switched network, schedule data from a terminal device comprising time parameters and content parameters for a plurality of activity entries, execute format validation and completeness verification on the schedule data, and store validated schedule data as structured records with temporal indexes in a storage device;
query the storage device to retrieve activity entries within a specified time window, extract temporal attributes and content attributes, tokenize a prompt sentence incorporating the extracted attributes, and transmit the tokenized prompt sentence to an inference engine executing a generative neural network model;
decode an output token sequence from the inference engine to obtain a proposal text string, parse the proposal text string using a temporal alignment procedure to map proposal records to corresponding time segments of the structured records, and compute overlay geometry parameters for each mapped proposal record; and
generate display control information encoding the overlay geometry parameters and transmit the display control information to the terminal device via the communication interface, and update the storage device with merged proposal records and a proposal acceptance rate used to adjust inference parameters in subsequent transmissions.

19. The system according to claim 18, wherein the circuitry is configured to retrieve prior proposal records from the storage device, generate an updated prompt sentence incorporating the prior proposal records and current schedule data, tokenize the updated prompt sentence, retransmit to the inference engine, and decode a revised proposal text string to generate revised mapped proposal records.

20. A method comprising:
receiving, via a communication interface coupled to a packet-switched network, schedule data from a terminal device comprising time parameters and content parameters for a plurality of activity entries, executing format validation and completeness verification on the schedule data, and storing validated schedule data as structured records with temporal indexes in a storage device in association with identification information;
querying the storage device to retrieve activity entries within a specified time window, extracting temporal attributes and content attributes from the retrieved structured records, tokenizing a prompt sentence incorporating the extracted attributes and an instruction for a generative neural network model to generate structured proposals, and transmitting the tokenized prompt sentence to an inference engine executing the generative neural network model; and
decoding an output token sequence from the inference engine to obtain a proposal text string, parsing the proposal text string to extract proposal records and map each proposal record to a corresponding time segment of the structured records, generating display control information that superimposes the mapped proposal records on a time-axis display representation of the schedule data, and transmitting the display control information to the terminal device via the communication interface.
